(19) United States
(12) Patent Application Publication
(10) Pub. No.: US 2003/0087061 A1
(43) Pub. Date: May 8, 2003

(54) Lithographic printing plate precursor

(75) Inventor: Hiroshi Tashiro, Shizuoka (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/225,393

(22) Filed: Aug. 22, 2002

(30) Foreign Application Priority Data
Aug. 23, 2001 (JP) P.2001-253137

(51) Int. Cl. B32B 1/00

(52) U.S. Cl. 428/141

(57) ABSTRACT

A lithographic printing plate precursor comprising at least an inter layer and an image-receiving layer provided in order on a water-resistant support, wherein the inter layer has a surface exhibiting a centerline average roughness (Ra) of from 0.05 to 2.0 μm.

### FIELD OF THE INVENTION

The present invention relates to a novel lithographic printing plate precursor. More particularly, it relates to a lithographic printing plate precursor, in particular, a direct drawing type lithographic printing plate precursor, capable of providing a lithographic printing plate that enables to print a great number of printed matters having clear images.

### BACKGROUND OF THE INVENTION

Along with the development of office appliances and the expansion of office automation in recent years, an offset printing system wherein a lithographic printing plate is prepared by subjecting a lithographic printing plate precursor comprising an image-receiving layer on a water-resistant support to plate-making, i.e., image formation according to various methods has been popularized in the filed of small-scale commercial printing.

A lithographic printing plate precursor hitherto known comprises an image-receiving layer provided on a water-resistant support, and a method is also known wherein an oleophilic image is formed on such a lithographic printing plate precursor by a typewriter or handwriting using an oily ink or according to heat-melt transfer of image from an ink ribbon by a thermal transfer printer and, if desired, the non-image area is subjected to a hydrophilic treatment, whereby a printing plate is prepared.

A conventional lithographic printing plate precursor comprises a support, for example, paper, having on one surface side thereof a surface layer, which functions as an image-receiving layer, provided via an interlayer and on the other surface side thereof a back layer. The interlayer and the back layer are each composed of a water-soluble resin, for example, PVA or starch, a water-dispersible resin, for example, a synthetic resin emulsion, and a pigment. The image-receiving layer ordinarily comprises an inorganic pigment, a water-soluble resin and a water-resisting agent.

It is proposed that as a binder resin used in an image-receiving layer of a lithographic printing plate precursor, a resin having a functional group capable of forming a carboxy group, a hydroxy group, a thiol group, an amino group, a sulfo group or a phosphono group upon decomposition and being previously crosslinked with heat-curable and/or photo-curable functional groups included therein is used as described in JP-A-1-226394, JP-A-1-269593 and JP-A-1-288488 (the term “JP-A” as used herein means an “unexamined published Japanese patent application”), a resin having the above-described functional group is used together with a heat-curable and/or photo-curable resin as described in JP-A-1-266546, JP-A-1-275191 and JP-A-1-309068, or a resin having the above-described functional group is used together with a curing agent as described in JP-A-1-267093, JP-A-1-271292 and JP-A-1-309067, for the purpose of improving hydrophilicity of the non-image area, film strength of the image-receiving layer and printing durability.

For improving hydrophilicity of the non-image area, it is also proposed that resin particles having a minute particle size of one μm or less and containing a hydrophilic group, for example, a carboxy group, a sulfo group or a phosphono group as described in JP-A-4-201387 and JP-A-4-223196, or resin particles having a minute particle size and containing a functional group capable of forming the hydrophilic group as described above upon decomposition as described in JP-A-4-319491, JP-A-4-353495, JP-A-5-119545, JP-A-5-58071 and JP-A-5-69684 are incorporated into the image-receiving layer together with an inorganic pigment and a binder resin.

However, in order to improve the printing durability of a printing plate obtained by a conventional manner as described above, if the hydrophobicity of the printing plate is enhanced by adding a large amount of the water resisting agent or by using a hydrophobic resin, printing stain due to the decrease in hydrophilicity occurs although the printing durability is improved. On the contrary, the enhancement of hydrophilicity results in lowering of the water resistance to cause deterioration of the printing durability.

Moreover, in case of a direct drawing type lithographic printing plate precursor, since images are directly drawn on an image-receiving layer of the printing plate precursor using means such as oily ink, poor adhesion of the oily ink to the image-receiving layer causes falling off of the oily ink in the image area during printing, thereby deteriorating the printing durability, even if the occurrence of printing stain in the non-image area is prevented based on the sufficient hydrophilicity thereof. This problem has not yet come to a satisfactory solution.

On the other hand, a printing plate precursor having a hydrophilic layer containing titanium oxide, polyvinyl alcohol and hydrolyzed tetramethoxysilane or tetraethoxysilane as an image-receiving layer has been proposed as described, for example, in JP-A-3-42679 and JP-A-10-268583. As a result of plate-making using such a printing plate precursor to prepare a printing plate and printing using the printing plate, however, it has been practically found that printing durability of the image is insufficient. Specifically, in case of using the printing plate thus-prepared, the image-receiving layer peels off during the printing procedure due to poor adhesion between the image-receiving layer and the support as well as the lack of image area during the printing procedure resulting from the insufficient strength of the image-receiving layer as described above and as a result, the sufficient printing durability cannot be obtained

### SUMMARY OF THE INVENTION

The present invention aims to solve the above-described problems.

Specifically, an object of the present invention is to provide a lithographic printing plate precursor capable of forming a lithographic printing plate that can provide a great number of printed matters having clear images.

Other objects of the present invention will become apparent from the following description.

It has been found that these objects of the present invention can be accomplished by providing an inter layer having a surface exhibiting a specific centerline average roughness (Ra) between a water-resistant support and an image-receiving layer.

The present invention includes the following items:

(1) A lithographic printing plate precursor comprising at least an inter layer and an image-receiving layer provided in order on a water-resistant support, wherein the inter layer has a surface exhibiting a centerline average roughness (Ra) of from 0.05 to 2.0 μm.

(2) The lithographic printing plate precursor as described in item (1) above, wherein the inter layer contains a resin and fine particles of inorganic pigment having an average particle diameter of from 0.005 to 1 μm.

(3) The lithographic printing plate precursor as described in item (2) above, wherein the fine particle of inorganic pigment having an average particle diameter of from 0.005 to 1 μm is at least one kind of inorganic pigment selected from colloidal silica, titania sol and alumina sol.

(4) The lithographic printing plate precursor as described in any one of items (1) to (3) above, wherein the water-resistant support is a polymer film or a composite film, and the polymer film or composite film has a coefficient of thermal expansion of not more than 15×10⁻⁵/° C. and a coefficient of thermal shrinkage of from −1.0 to less than +1.0 under heating at 150° C. for 30 minutes.

(5) The lithographic printing plate precursor as described in item (1) above, wherein the image-receiving layer contains at least one kind of particle selected from a metal oxide hydrate particle, a metal oxide particle and a double oxide particle each having an average particle diameter of from 0.01 to 5 μm and being composed of atoms having a Pauling ionicity rate of not less than 0.2 between the atoms and a binder resin comprising a complex of a resin containing a siloxane bond wherein a silicon atom is connected with an oxygen atom and an organic polymer containing a group capable of forming a hydrogen bond with the resin containing a siloxane bond.

(6) The lithographic printing plate precursor as described in item (5) above, wherein the resin containing a siloxane bond is a polymer obtained by a hydrolysis co-condensation of at least one silane compound represented by the following formula (III):

(R⁰)ₘSi(Y)₄₋ₘ (III)

wherein R⁰ represents a hydrogen atoms, a hydrocarbon group or a heterocyclic group; Y represents a reactive group; and m represents 0, 1 or 2, provided that the silicon atom is not connected to 3 hydrogen atoms or 4 hydrogen atoms.

(7) The lithographic printing plate precursor as described in item (1) above, wherein the image-receiving layer is a layer formed from a dispersion containing silica particles having an average particle diameter of from 1 to 6 μm and ultra-fine particles of inorganic pigment having an average particle diameter of from 5 to 50 nm in a weight ratio of from 40/60 to 70/30, as an inorganic pigment and at least one kind of hydrophilic resin modified with a silyl functional group represented by the following formula (I):

—Si(R)ₙ(OX)₃₋ₙ (I)

wherein R represents a hydrogen atom or a hydrocarbon group having from 1 to 12 carbon atoms, X represents an aliphatic group having from 1 to 12 carbon atoms, and n represents 0, 1 or 2.

(8) The lithographic printing plate precursor as described in item (7) above, wherein the image-receiving layer is a layer formed from the dispersion further containing gelatin and a gelatin hardening compound.

(9) The lithographic printing plate precursor as described in item (7) or (8) above, wherein the ultra-fine particles of inorganic pigment having an average particle diameter of from 5 to 50 nm is at least one inorganic pigment selected from colloidal silica, titania sol and alumina sol.

(10) The lithographic printing plate precursor as described in item (8) above, wherein the gelatin hardening compound is a compound containing at least two double bond groups represented by formula (II) shown below in the molecule thereof.

CH₂═CH—W— (II)

wherein W represents —OSO₂—, —SO₂—, —CONR¹— or —SO₂NR¹— (wherein R¹ represents a hydrogen atom or an aliphatic group having from 1 to 8 carbon atoms).

(11) The lithographic printing plate precursor as described in any one of items (1) to (10) above, wherein the image-receiving layer has a surface smoothness of not less than 30 (sec/10 ml) in terms of Bekk smoothness.

### BRIEF DESCRIPTION OF THE ACCOMPANYING DRAWINGS

FIG. 1 is a schematic view showing an example of an apparatus system by which plate-making of the lithographic printing plate precursor of the present invention is conducted.

FIG. 2 is a schematic view showing the main part of an ink jet recording device by which plate-making of the lithyographic printing plate precursor of the present invention is conducted.

FIG. 3 is a partially cross sectional view of a head of an ink jet recording device by which plate-making of the lithographic printing plate precursor of the present invention is conducted.

In these figures, the numerals denote the following members, respectively:

1 Ink jet recording device

2 Lithographic printing plate precursor (Master)

3 Computer

4 Bus

5 Video camera

6 Hard disk

7 Floppy disc

8 Mouse

10 Head

10a Ejection slit

10b Ejection electrode

10c Counter electrode

11 Oily ink

101 Upper unit

102 Lower unit

### DETAILED DESCRIPTION OF THE INVENTION

Techniques of providing an inter layer between a water-resistant support and an image-receiving layer in a lithographic printing plate precursor are known as described, for example, in page 4, right upper column, line 8 of JP-A-61-286200. However, neither disclose nor suggest an inter layer having the special features as in the present invention. The lithographic printing plate precursor of the present invention comprises an image-receiving layer provided on a water-resistant support via a specific inter layer, and a lithographic printing plate obtained by forming images on the image-receiving layer according to the present invention can provide a great number of printed matters having clear images

The present invention will be described in greater detail low.

The inter layer according to the present invention has a surface exhibiting a centerline average roughness (Ra) of from 0.05 to 2.0 μm. It has been found that the adhesion to the image-receiving layer, which constitutes an upper layer, is remarkably improved by defining the surface smoothness in the above range. It is believed that fine irregularities are formed on the surface of inter layer by controlling the surface smoothness in the above range and when an image-receiving layer is applied onto the inter layer, the image-receiving layer may get partially into the irregularities on the surface of inter layer to be anchored, whereby the sufficient adhesion is achieved. The Ra value of the surface of inter layer is preferably from 0.1 to 1.0 μm. The thickness of inter layer is not particularly restricted and it is preferably in a range of from 0.5 to 10 μm.

The centerline average roughness (Ra) is a value obtained by extracting a part of the roughness curve in a measure length of L in the direction of the centerline and calculating the arithmetic mean of the absolute values of deviation between the centerline of the extracted part and the roughness curve. The value can be measured using, for example, a surface roughness measuring instrument (SE-3400 manufactured by Kosaka Laboratory Ltd.). The measurement is conducted according to the standard of ISO-468, and specifically described in detail, for example, in Jiro Nara, Hyomen-arasa no Sokutei.Hyoka Hou (Methods for Measurement and Evaluation of Surface Roughness), Sogogijutu Center Co., Ltd. (1983).

In order to adjust the centerline average roughness (Ra) of the surface of inter layer to the above-described specific range, a method of controlling surface configuration of the inter layer by dispersing fine inorganic particles (filler) in a resin for forming the inter layer, a method of controlling surface configuration of the inter layer by controlling surface configuration of the water-resistant support, and a method of controlling surface configuration of the inter layer at the time of drying thereof by selecting a solvent for coating the inter layer, for example, a combination of a high-boiling point solvent and a low-boiling point solvent or a combination of a good solvent and a poor solvent can be employed.

Materials for forming the inter layer include various resins and dispersions of such resins and inorganic particles, and these are appropriately selected to use.

Specific examples of the inorganic particles include kaolin, clay, talc, calcium carbonate, silica, titanium oxide, zinc oxide, barium sulfate, alumina, iron hydroxide, aluminum hydroxide, titanium oxide hydrate and zinc oxide hydrate.

In particular, it is preferred to incorporate fine particles of inorganic pigment having an average particle diameter of from 0.005 to 1 μm into the inter layer. The fine particles of inorganic pigment having an average particle diameter of from 0.005 to 1 μm are not particularly restricted and conventionally known compounds can be used. Preferred examples thereof include silica sol, titania sol, alumina sol, titanium oxide, titanium oxide hydrate, magnesium oxide, magnesium carbonate, zinc oxide, nickel oxide and zirconium oxide. At least one of the silica sol, titania sol and alumina sol is more preferred.

The silica sol is a dispersion in which ultra-fine silica particles of a particle diameter of from 1 to 100 nm having many hydroxy groups on the surfaces thereof and being composed of siloxane bonds (—Si—O—Si—) in the inside thereof are dispersed in water or a polar solvent. The silica sol is also referred to as “colloidal silica”. The silica sol is specifically described in Toshiro Kagami and Akira Hayashi supervised, Kojundo Silica no Oyogijutsu (Applied Technology of High Purity Silica), Chapter 3, CMC Publishing Co. (1991).

The alumina sol is a dispersion of alumina hydrate (boehmite-type structure) having a colloid size of from 5 to 200 nm in water, in which an anion (for example, a halide ion, e.g., fluoride ion or chloride ion, or a calboxylate anion, e.g., acetate ion) in water functions as a stabilizer.

The titania sol is a dispersion of TiO₂, Ti(O)(OH)₂ or a mixture thereof having a colloid size of from 5 to 500 nm in water.

Of the colloidal fine particles described above, those having an average particle diameter of from 5 to 50 nm are preferably used in the inter layer according to the present invention, and those having an average particle diameter of from 5 to 40 nm are more preferred. The fine particles of inorganic pigment are easily available as commercial products.

The resin used for forming the inter layer can be appropriately selected from various kinds of resins. Specifically, examples of the resin include olefin homopolymers and copolymers (e.g., polyethylene, polypropylene, polyisobutylene, ethylene-vinyl acetate copolymer, ethylene-acrylate copolymer, ethylene-methacrylate copolymer or ethylene-methacrylic acid copolymer), vinyl chloride homopolymers and copolymers (e.g., polyvinyl chloride or vinyl chloride-vinyl acetate copolymer), vinylidene chloride copolymers, vinyl alkanate homopolymers and copolymers, allyl alkanate homopolymers and copolymers, homopolymers and copolymers of styrene and derivatives thereof (e.g., butadiene-styrene copolymer, isoprene-styrene copolymer, styrene-methacrylate copolymer or styrene-acrylate copolymer), acrylonitrile copolymers, methacrylonitrile copolymers, alkyl vinyl ether copolymers, acrylate homopolymers and copolymers, methacrylate homopolymers and copolymers, diitaconate homopolymers and copolymers, maleic anhydride copolymers, acrylamide copolymers, methacrylamide copolymers, phenolic resins, alkyd resins, polycarbonate resins, ketone resins, polyester resins, silicon resins, amide resins, hydroxy group- and carboxyl group-modified polyester resins, butyral resins, polyvinyl acetal resins, urethane resins, rosin resins, hydrogenated rosin resins, petroleum resins, hydrogenated petroleum resins, maleic resins, terpene resins, hydrogenated terpene resins, chroman-indene resins, cyclized rubber-methacrylate copolymers, cyclized rubber-acrylate copolymers, copolymers containing a heterocyclic ring free from a nitrogen atom (examples of the heterocyclic ring include a furan ring, a tetrahydrofuran ring, a thiophene ring, a dioxane ring, a dioxofuran ring, a lactone ring, a benzofuran ring, a benzothiophene ring and a 1,3-dioxetane ring), and expoxy resins.

Specific examples of the natural and semisynthetic polymers include cellulose, cellulose derivatives (for example, cellulose esters, e.g., cellulose nitrate, cellulose sulfate, cellulose acetate, cellulose propionate, cellulose succinate, cellulose butyrate, cellulose acetate succinate, cellulose acetate butyrate or cellulose acetate phthalate, and cellulose ethers, e.g., methylcellulose, ethylcellulose, cyanoethylcellulose, carboxymethylcellulose, hydroxyethylcellulose, hydroxypropylcellulose, ethyl hydroxyethylcellulose, hydroxypropyl methylcellulose or carboxymethyl hydroxyethylcellulose), starch, starch derivatives (for example, oxidized starch, esterified starches including those esterified with an acid, e.g., nitric acid, sulfuric acid, phosphoric acid, acetic acid, propionic acid, butyric acid or succinic acid, and etherified starches, e.g., methylated starch, ethylated starch, cyanoethylated starch, hydroxyalkylated starch or carboxymethylated starch), alginic acid, pectin, carrageenan, tamarind gum, natural rubber (e.g., gum arabic, guar gum, locust bean gum, tragacanth gum or xanthane gum), pullulan, dextran, casein, gelatin, chitin and chitosan.

Specific examples of the synthetic polymer include polyvinyl alcohol, polyalkylene glycols (e.g., polyethylene glycol, polypropylene glycol or ethylene glycol/propylene glycol copolymers), allyl alcohol copolymers, homopolymers or copolymers of acrylate or methacrylate containing at least one hydroxy group (examples of the ester portion including 2-hydroxyethyl, 3-hydroxypropyl, 2,3-dihydroxypropyl, 3-hydroxy-2-hydroxymethyl-2-methylpropyl, 3-hydroxy-2,2-di(hydroxymethyl)propyl, polyoxyethylene and polyoxypropylene groups), homopolymers or copolymers of N-substituted acrylamide or methacrylamide containing at least one hydroxy group (examples of the N-substituent including monomethylol, 2-hydroxyethyl, 3-hydroxypropyl, 1,1-bis(hydroxymethyl)ethyl and 2,3,4,5,6-pentahydroxypentyl groups).

A ratio of the fine particle of inorganic pigment to the resin in the inter layer is preferably from 1/99 to 90/10 by weight, and more preferably from 5/95 to 70/30 by weight.

To the inter layer, a cross-linking agent may also be added in order to further increase the water-resistance and film-strength thereof. The cross-linking agent for use in the inter layer includes compounds ordinarily used as cross-linking agents. Specifically, compounds as described, e.g., in Shinzo Yamashita and Tosuke Kaneko ed., Kakyozai Handbook (Handbook of Cross-linking Agents), Taiseisha (1981) and Kobunshi Gakkai ed., Kobunshi Data Handbook—Kisohen—(Polymer Data Handbook, Fundamental Volume), Baifukan (1986) are used.

Examples of the cross-linking agent which can be used include ammonium chloride, a metal ion, an organic peroxide, a polyisocyanate compound (e.g., toluylene diisocyanate, diphenylmethane diisocyanate, triphenylmethane triisocyanate, polymethylene phenylisocyanate, hexamethylene diisocyanate, isophorone diisocyanate or a high molecular polyisocyanate), a polyol compound (e.g., 1,4-butanediol, polyoxypropylene glycol, polyoxyethylene glycol or 1,1,1-trimethylolpropane), a polyamine compound (e.g., ethylenediamine, γ-hydroxypropylated ethylenediamine, phenylenediamine, hexamethylenediamine, N-aminoethylpiperazine or a modified aliphatic polyamine), a polyepoxy group-containing compound and an epoxy resin (e.g., compounds as described in Hiroshi Kakiuchi, Shin Epoxy Jushi (New Epoxy Resins), Shokodo (1985) and Kuniyuki Hashimoto, Epoxy Jushi (Epoxy Resins), The Nikkan Kogyo Shinbun, Ltd. (1969)), a melamine resin (e.g., compounds as described in Ichiro Miwa and Hideo Matsunaga, Urea.Melamine Jushi (Urea.Melamine Resins), The Nikkan Kogyo Shinbun, Ltd. (1969)), and a poly(meth)acrylate compound (e.g., compounds as described in Makoto Ogawara, Takeo Saegusa and Toshinobu Higashimura ed., Oligomer (Oligomers), Kodansha Ltd. (1976) and Eizo Omori, Kinousei Acryl Kei Jushi (Functional Acrylic Resins), Techno System (1985)).

The water-resistant support for use in the present invention includes paper treated with a water-resistant agent, a plastic film and a metal plate (e.g., aluminum plate). When high dimensional stability is requested, specifically, in case of performing printing of high image quality and highly precise images, it is preferred to employ a support having a specific coefficient of thermal expansion and a specific coefficient of thermal shrinkage. More specifically, a polymer film or a composite film having a coefficient of thermal expansion of not more than 15×10⁻⁵/° C., more preferably not more than 10×10⁻⁵/° C., and a coefficient of thermal shrinkage of from −1.0 to less than +1.0, more preferably from −0.5 to less than +1.0 under heating at 150° C. for 30 minutes. By using a support having such physical properties, the high dimensional stability is achieved at the time of heat treatment for fixing at plate-making, whereby clear images are obtained.

Examples of the polymer film include polyethylene naphthanate (PEN), polyphenylene sulfide (PPS), polyether ether ketone (PEEK), polyimide, polyamideimide, polysulfone (PSF), amorphous polyacrylate (PAR), polyether sulfone (PES), polyether imide (PEI), cellulose triacetate, cellulose acetate butyrate, cellulose tributyrate and polystyrene. More specifically, polymer films and composite films as described, for example, in Polymer Film and Kinousel Maku (Polymer Film and Functional Membrane), Gihodo Co., Ltd. (1991), Plastic Handbook, Kogyochosakai (1980) and Plastic Film—Kako to Oyo—(Plastic Film—Processing and Application—), 2nd Edition, Gihodo Co., Ltd. (1995) can be used. The term “composite film” means a film obtained by laminating plural plastic films by means of, for example, an extrusion T laminate method. Examples of the composite film include a PET/PE film and a PEN/PE film.

The support preferably has a thickness of from 50 to 200 μm. At a thickness in such a range, the good handling property as well as the sufficient strength can be obtained. Particularly, it is preferred to use a support having a thickness of from 70 to 200 μm. At a thickness in such a range, more improved aptitude to an automatic plate supplying and discharging printing machine and better handling property can be obtained.

It is preferable for the lithographic printing plate precursor for use in the present invention to have electric conductivity. Specifically, it is preferred that the lithographic printing plate precursor has the specific electric resistance of not more than 10¹⁰ Ω·cm. The specific electric resistance of not more than 10⁸ Ω·cm is more preferred, and the value of specific electric resistance may be infinitely close to zero.

Such a lithographic printing plate precursor is advantageously used when the image formation thereon is conducted by s laser printer or an ink jet method. Specifically, by earthing the lithographic printing plate precursor, charged ink droplets just after attaching to the image-receiving layer can quickly lose their electric charges through earthing. Thus, clear images free from disorder can be formed, the drawing property of image toner (density and clearness) can be improved, and the printing durability can be increased.

The specific electric resistance (also referred to as volume specific electric resistance or specific resistivity, sometimes) is measured by a three-terminal method with a guard electrode according to the method described in JIS K-6911.

In order to provide electric conductivity to the lithographic printing plate precursor, for example, making the water-resistant support itself or the inter layer itself conductive or applying a conductive material to at least one side surface, more preferably both side surfaces of the lithographic printing plate precursor is practically conducted. In particular, the lithographic printing plate precursor having conductivity on the side surface thereof is advantageous since earthing is easily performed from the side surface. It is sufficient to provide conductivity only on one side surface of the lithographic printing plate precursor for the purpose of taking such advantage. However, when the both side surfaces of lithographic printing plate precursor are conductive, more effective earthing becomes possible and the drawing quality of image and printing durability are more improved. The term “one side surface” of the lithographic printing plate precursor means a surface of the lithographic printing plate precursor vertical to a surface of image-receiving layer provided thereon. still more preferably, the conductivity is provided on the right and left vertical surfaces of a lithographic printing plate precursor in the direction of plate-making of the lithographic printing plate precursor.

In order to impart the electric conductivity as described above on the image-receiving layer side (i.e., the surface adjacent to the inter layer) of water-resistant support, a method of applying a conductive resin layer comprising an electrically conductive filler, for example, carbon black and a binder to the support, a method of sticking a metal foil on the support, or a method of vapor-depositing metal onto the support.

The formation of conductive material can be performed by applying a conductive resin containing a conductive filler and a binder at least one surface of the water-resistant support and further at least one side surface of the water-resistant support. The thickness of conductive resin applied is preferably from 0.5 to 20 μm.

Examples of the conductive filler include granular carbon black or graphite, metal powder, for example, silver, copper, nickel, brass, aluminum, steel or stainless steel powder, tin oxide powder, flaky aluminum or nickel, and fibrous carbon.

The binder constituting the conductive material or conductive resin layer can be appropriately selected from various kinds of resins. Examples of a resin suitable for the binder include hydrophobic resins, for example, acrylic resins, vinyl chloride resins, styrene resins, styrene-butadiene resins, styrene-acrylic resins, urethane resins, vinylidene chloride resins and vinyl acetate resins, and hydrophilic resins, for example, polyvinyl alcohol resins, cellulose derivatives, starch and derivatives thereof, polyacrylamide resins and copolymers of styrene and maleic anhydride.

Another method for forming the conductive material or conductive resin layer is to laminate a conductive thin film. Examples of such a conductive thin film include a metallic foil and a conductive plastic film. More specifically, an aluminum foil can be used for the metallic foil, and a polyethylene resin film in which carbon black is incorporated can be used for the conductive plastic film. Both hard and soft aluminum foils can be used as the laminating material. The thickness of conductive thin film is preferably from 0.5 to 20 μm.

For the lamination of a polyethylene resin in which carbon black is incorporated, it is preferred to adopt an extrusion lamination method. The extrusion lamination method includes the steps of melting the polyethylene resin by heating, forming the molten resin into a film, pressing the film immediately to the base paper and cooling them, and can be carried out with various well-known apparatuses. The thickness of laminated layer is preferably from 10 to 30 μm. Carbon black may be incorporated into the polyethylene coated layer to serve as the conductive material or conductive resin layer.

In the manner as described above, the lithographic printing plate precursor having the specific electric resistance of not more than 10¹⁰ Ω·cm is obtained.

In the present invention, surface smoothness of the side of the water-resistant support opposite to the side on which the inter layer is coated is from 5 to 2,000 (sec/10 ml), preferably from 50 to 1,500 (sec/10 ml), and more preferably from 100 to 500 (sec/10 ml), in terms of Bekk smoothness. In the above-described range of surface smoothness, it is believed that distortion of a printing plate imposed at the time of printing, for example, distortion of the printing plate caused by the friction with a blanket during the printing, can be prevented and as a result, the printing dimension and accuracy can be maintained. The reason for this is presumed that the frictional resistance between the printing plate and a plate cylinder of printing machine is one of the big factors for preventing the distortion.

The term “Bekk smoothness” as used herein means a Bekk smoothness degree measured by a Bekk smoothness tester. In the Bekk smoothness tester, a sample piece is pressed against a circular glass plate having a surface of highly smooth finish and a hole at the center while applying thereto a definite pressure (1 kg/cm²), and a definite volume (10 ml) of air is forced to pass between the sample piece and the glass surface under reduced pressure. Under this condition, a time (expressed in second) required for the air passage is measured.

The image-receiving layer according to the present invention is provided on the inter layer provided on the water-resistant support. The thickness of image-receiving layer is not particularly restricted and suitably in a range of from 5 to 30 μm.

The image-receiving layer according to the present invention preferably has a surface smoothness of not less than 30 (sec/10 ml) in terms of Bekk smoothness. In a case of plate-making where images are formed on the lithographic printing plate precursor by means of an electrophotographic printer, an appropriate range of the Bekk smoothness may be varied depending on whether toner used in the electrophotographic printer is dry toner or liquid toner as described below.

More specifically, in the case of using dry toner in the electrophotographic printer, the Bekk smoothness of image-receiving layer surface of the lithographic printing plate precursor is preferably from 30 to 200 (sec/10 ml), and more preferably from 50 to 150 (sec/10 ml). At a smoothness in such a range, the undesirable attachment of scattered toner to the non-image area (occurrence of background stain) is prevented and the toner adheres uniformly and firmly to the image area in the processes of transferring and fixing the toner image to the printing plate precursor, whereby satisfactory reproduction of fine lines and fine letters and uniformity in the solid image area can be achieved.

In the case of using liquid toner in the electrophotographic printer, the Bekk smoothness of image-receiving layer surface of the lithographic printing plate is not less than 30 (sec/10 ml), and as the Bekk smoothness is higher, the toner images transferred and fixed thereto exhibit better quality. Specifically, the range thereof is preferably from 150 to 3,000 (sec/10 ml), and more preferably from 200 to 2,500 (sec/10 ml).

In a case where images are formed by means of an ink jet printer or a thermal transfer printer, the Bekk smoothness of image-receiving layer surface of the lithographic printing plate precursor is preferably in the range described above for the case of using liquid developer in the electrophotographic printer.

At a smoothness in such a range, highly accurate toner images such as fine lines, fine letters or dots can be transferred faithfully to the image-receiving layer, and fixed on the surface thereof so firmly as to ensure sufficient strength in the image area.

A hydrophilic layer comprising an inorganic pigment and a binder resin or a layer capable of converting to hydrophilic upon oil-desensitizing treatment can be employed as the image-receiving layer.

One embodiment of the image-receiving layer for use in the present invention is a layer prepared by coating a dispersion containing silica gel particle/gelatin or metal oxide/hydrophilic resin as the main component as described, for example, in JP-A-10-250254 and JP-A-2000-247052. Also, as the main component of binder resin, a hydrophilic resin having a silyl functional group as described, for example, in JP-A-2000-233580 is preferably used

The inorganic pigment for use in the image-receiving layer of the present invention includes inorganic pigments, for example, clay, zinc oxide, titanium oxide or silica, and those described, for example, in Mukikagobutu.Sakutai Jiten (Dictionary of Inorganic Compounds and Complexes), Kodansha Ltd. (1979) and Toryo.Ganryo (Paints and Pigments), The Nikkan Kogyo Shinbun, Ltd. (1960). Among them, a combination use of silica particles having an average particle diameter of from 1 to 6 μm and ultra-fine particles of inorganic pigment having an average particle diameter of from 5 to 50 nm is preferred.

The silica particles preferably have an average particle diameter of from 1.0 to 4.5 μm. The silica particles are finely divided amorphous synthetic silica powder comprising silicon dioxide as a main component (99% or more) and having no crystalline structure. Such silica particles are specifically described, for example, in Toshiro Kagami and Akira Hayashi supervised, Kojundo Silica no Oyogijutsu (Applied Technology of High Purity Silica), Chapters 4 and 5, CMC Publishing Co. (1991). The finely divided synthetic silica powder has a well-controlled porosity and pore volume and an average particle diameter of from 1 to 6 μm. However, other properties, for example, pore diameter, pore volume, oil absorption amount and surface silanol group density of the finely divided synthetic silica powder are not specifically limited. The finely divided synthetic silica powders are easily available as commercial products.

As the ultra-fine particles of inorganic pigment having an average particle diameter of from 5 to 50 nm, conventionally well-known compounds can be exemplified. Preferred examples of such compounds include silica sol, titania sol, alumina sol, titanium oxide, titanium oxide hydrate, magnesium oxide, magnesium carbonate, zinc oxide, nickel oxide and zirconium oxide. More preferred examples thereof include at least one of silica sol, titania sol and alumina sol.

The silica sol is a dispersion in which ultra-fine silica particles of a particle diameter of from 1 to 100 nm having many hydroxyl groups on the surface thereof and being composed of siloxane bonds (—Si—O—Si—) in the inside thereof are dispersed in water or a polar solvent. The silica sol is also referred to as “colloidal silica”. The silica sol is specifically described in the above-described Kojundo Silica no Oyogijutsu (Applied Technology of High Purity Silica), Chapter 3.

The alumina sol is a dispersion of alumina hydrate (boehmite-type structure) having a colloidal size of from 5 to 200 nm in water, in which an anion (for example, a halide ion, e.g., fluoride ion or chloride ion, or a carboxylate anion, e.g., acetate ion) in water functions as a stabilizer.

The titania sol is a dispersion of TiO₂, Ti(O)(OH)₂ or a mixture thereof having a colloid size of from 5 to 500 nm in water.

Of the colloidal fine particles described above, those having an average particle diameter of from 5 to 50 nm are preferably used in the image-receiving layer according to the present invention, and those having from 5 to 40 nm are more preferred. The ultra-fine particles of inorganic pigment are easily available as commercial products.

A ratio of the silica particles to the ultra-fine particles of inorganic pigment is preferably from 40/60 to 70/30 by weight, and more preferably from 45/55 to 60/40 by weight.

By controlling each particle diameter of the silica particles and the ultra-fine particles of inorganic pigment for use in the present invention as the inorganic pigment and the weight ratio thereof in the above-described range, the resulting image-receiving layer maintains a sufficient film strength, and when the printing plate precursor obtained is subjected to plate-making using various printers, the occurrence of stain due to adhesion of toner or ink to the non-image area is suppressed on a practically acceptable level and highly accurate images such as fine lines, fine letters or fine dots are clear without disappearance, distortion and blur. Further, when the printing plate obtained is subjected to printing, the non-image area has excellent hydrophilicity and is prevented from adhesion of printing ink and, at the same time, in the image area, toner or ink firmly adheres to the image-receiving layer, thus, an excellent result that disappearance of image does not occur after a large number of sheets are printed can be obtained.

The image-receiving layer according to the present invention preferably contains as the hydrophilic resin, at least a hydrophilic resin modified with a silyl functional group represented by formula (I) shown below.

By using such a hydrophilic resin, the surface of image-receiving layer according to the present invention becomes sufficiently hydrophilic and also adhesion of the image can be improved, as a result, the printing durability of printing plate is markedly improved.

—Si(R)ₙ(OX)₃₋ₙ (I)

wherein R represents a hydrogen atom or a hydrocarbon group having from 1 to 12 carbon atoms, X represents an aliphatic group having from 1 to 12 carbon atoms, and n represents 0, 1 or 2.

In formula (I), preferred examples of the hydrocarbon group represented by R include an alkyl group having from 1 to 12 carbon atoms which may be substituted (e.g., methyl, ethyl, propyl, butyl, pentyl, hexyl, heptyl, octyl, nonyl, decyl, dodecyl, 2-hydroxyethyl, 2-methoxyethyl, 2-cyanoethyl, 2-ethoxyethyl, 3,6-dioxoheptyl, 3-sulfopropyl, 2-carboxyethyl, 2-methoxycarbonylethyl, 3-chloropropyl, 3-bromopropyl, 2,3-dihydroxypropyl or trifluoroethyl), an alkenyl group having from 3 to 12 carbon atoms which may be substituted (e.g., propenyl, butenyl, pentenyl, hexenyl, heptenyl, octenyl, nonenyl or decenyl), an aralkyl group having from 7 to 12 carbon atoms which may be substituted (e.g., benzyl, phenethyl, 3-phenylpropyl, chlorobenzyl, bromobenzyl, methylbenzyl, ethylbenzyl, methoxybenzyl, dimethylbenzyl, dimethoxybenzyl or carboxybenzyl), an alicyclic group having from 5 to 8 carbon atoms which may be substituted (e.g., cyclopentyl, cyclohexyl, 2-cyclohexylethyl or 2-cyclopentylethyl), and an aromatic group having from 6 to 12 carbon atoms which may be substituted (e.g., phenyl, naphthyl, tolyl, xylyl, propylphenyl, butylphenyl, octylphenyl, dodecylphenyl, methoxyphenyl, ethoxyphenyl, butoxyphenyl, decyloxyphenyl, chlorophenyl, dichlorophenyl, bromophenyl, cyanophenyl, acetylphenyl, methoxycarbonylphenyl, ethoxycarbonylphenyl, butoxycarbonylphenyl, acetamidophenyl, propionamidophenyl, carboxyphenyl, sulfopehnyl or carboxymethylphenyl).

In formula (I), X represents an aliphatic group having from 1 to 12 carbon atoms. Preferred examples of the aliphatic group include an alkyl group having from 1 to 8 carbon atoms which may be substituted (e.g., methyl, ethyl, propyl, butyl, pentyl, hexyl, heptyl, octyl, 2-methoxyethyl, 2-ethoxyethyl, 3-methoxypropyl, 3,6-dioxoheptyl or 2-oxobutyl), an alkenyl group having from 3 to 8 carbon atoms which may be substituted (e.g., propenyl, butenyl, pentenyl, hexenyl, heptenyl or octenyl), an aralkyl group having from 7 to 12 carbon atoms which may be substituted (e.g., benzyl, phenethyl, 3-phenylpropyl, chlorobenzyl, bromobenzyl, methylbenzyl, ethylbenzyl, methoxybenzyl, dimethylbenzyl or dimethoxybenzyl), and an alicyclic group having from 5 to 8 carbon atoms which may be substituted (e.g., cyclopentyl, cyclohexyl, cycloheptyl or cyclooctyl). More preferred examples of the aliphatic group represented by X include an alkyl group having from 1 to 4 carbon atoms which may be substituted.

In formula (I), n represents 0, 1 or 2, and preferably 0 or 1.

The organic polymer containing a silyl functional group represented by formula (I) can be synthesized according to known methods. Specifically, the organic polymer is easily obtained by modifying a hydroxyl group in a hydroxy group-containing resin with a silyl functional group as described, for example, in Hannosei Polymer no Gosei to Oyo (Synthesis and Application of Reactive Polymers), CMC Publishing Co. (1989), JP-B-46-30711 (the term “JP-B” as used herein means an “examined Japanese patent publication”) and JP-A-5-32931. The hydroxyl group-containing resin may be any of natural polymers, semisynthetic polymers and synthetic polymers, and specific examples thereof include those described, for example, in Keiei Kaihatsu Center Publishing Division ed., Suiyosei Kobunshi.Mizubunsangata Jushi Sogo Gijutsu Shiryoshu (Water-Soluble Polymers.Aqueous Dispersion Type Resins, Collective Technical Data, published by Keiei Kaihatsu Center Publishing Division (1981), Shinji Nagatomo, Shin Suiyosei Polymer no Oyo to Shijo (New Application and Market of Water-Soluble Polymers), CMC Publishing Co. (1988), Kinosei Cellulose no Kaihatsu (Development of Functional Cellulose), CMC Publishing Co. (1985), and Munio Kotake supervised, Dai Yukikagaku (Grand Organic Chemistry), Vol. 19: Tennen Kobunshi Kagobutsu (Natural Polymer Compounds) I, Asakura Shoten Co. (1960).

Specific examples of the natural and semisynthetic polymers include cellulose, cellulose derivatives (for example, cellulose esters, e.g., cellulose nitrate, cellulose sulfate, cellulose acetate, cellulose propionate, cellulose succinate, cellulose butyrate, cellulose acetate succinate, cellulose acetate butyrate or cellulose acetate phthalate; and cellulose ethers, e.g., methyl cellulose, ethyl cellulose, cyanoethyl cellulose, carboxymethyl cellulose, hydroxyethyl cellulose, hydroxypropyl cellulose, ethylhydroxyethyl cellulose, hydroxypropylmethyl cellulose or carboxymethylhydroxyethyl cellulose), starch, starch derivatives (for example, oxidized starch, esterified starches including those esterified with an acid, e.g., nitric acid, sulfuric acid, phosphoric acid, acetic acid, propionic acid, butyric acid or succinic acid, and etherified starches, e.g., methylated starch, ethylated starch, cyanoethylated starch, hydroxyalkylated starch or carboxymethylated starch), alginic acid, pectin, carrageenan, tamarind gum, natural rubber (e.g., gum arabic, guar gum, locust bean gum, tragacanth gum or xanthane gum), pullulan, dextran, casein, gelatin, chitin and chitosan.

Specific examples of the synthetic polymer include polyvinyl alcohol, polyalkylene glycol (e.g., polyethylene glycol, polypropylene glycol or ethylene glycol-propylene glycol copolymers), allyl alcohol copolymers, acrylate copolymers, methacrylate copolymers, homopolymers or copolymers of acrylate or methacrylate containing at least one hydroxy group (examples of the ester portion including 2-hydroxyethyl, 3-hydroxypropyl, 2,3-dihydroxypropyl, 3-hydroxy-2-hydroxymethyl-2-methylpropyl, 3-hydroxy-2,2-di(hydroxymethyl)propyl, polyoxyethylene group and polyoxypropylene groups), and homopolymers or copolymers of N-substituted acrylamide or methacrylamide containing at least one hydroxy group (examples of the N-substituent including monomethylol, 2-hydroxyethyl, 3-hydroxypropyl, 1,1-bis(hydroxymethyl)ethyl and 2,3,4,5,6-pentahydroxypentyl groups). However, the synthetic polymer is not particularly limited as far as it contains at least one hydroxy group in a side chain substituent of the repeating unit thereof.

A weight average molecular weight of the hydrophilic resin is preferably from 10³ to 10⁶, and more preferably from 5×10³ to 4×10⁵.

A content of the silyl functional group in the hydrophilic resin is ordinarily from 0.01 to 50 mol %, preferably from 0.1 to 20 mol %, and more preferably from 0.2 to 15 mol %, in terms of a unit component having the silyl functional group. When the hydrophilic resin is saccharide or protein, the unit component means monosaccharide or amino acid, which constitutes the saccharide or protein, respectively. The unit component may have plural silyl functional groups.

The silyl functional group may be connected to a side chain of the repeating unit of the polymer or a terminal of the polymer main chain directly or via a linking group. Any linking group may be used and examples thereof include —O—, —CR¹¹R¹²— (where R¹¹ and R¹², which may be the same or different, each represent a hydrogen atom, a halogen atom (e.g., fluorine, chlorine or bromine), a hydroxy group, a cyano group, an alkyl group (e.g., methyl, ethyl, 2-chloroethyl, 2-hydroxyethyl, propyl or butyl), an aralkyl group (e.g., benzyl or phenethyl) or a phenyl group), —S—, —NR¹³— (where R¹³ represents a hydrogen atom or a hydrocarbon group (the hydrocarbon group including a hydrocarbon group having from 1 to 8 carbon atoms (e.g., methyl, ethyl, propyl, butyl, hexyl, 2-methoxyethyl, 2-chloroethyl, 2-cyanoethyl, benzyl, methylbenzyl, phenethyl, phenyl, tolyl, chlorophenyl or methoxyphenyl))), —CO—, —COO—, —OCO—, —CONR¹³—, —SO₂NR¹³—, —SO₂—, —NHCONH—, —NHCOO—, —NHSO₂—, —CONHCOO— and —CONHCONH—. These linking groups may be used individually or in combination of two or more thereof.

The hydrophilic resins containing the silyl functional group represented by formula (I) may be used individually or in combination of two or more thereof in the present invention.

The hydrophilic resin easily forms a siloxane bond represented by formula (I′) shown below upon a condensation reaction of the —Si(R)ₙ(OX)₃₋ₙ group to cause crosslinkage between the resins during a drying step with heating after the formation of layer, whereby the image-receiving layer is hardened to maintain a sufficient film strength. Although the reason for this is not defined in detail, it is believed that the surface of image-receiving layer according to the present invention is sufficiently hydrophilic and, at the same time, adhesion of the image thereto is extremely good and thus the printing durability of printing plate prepared is dramatically improved.

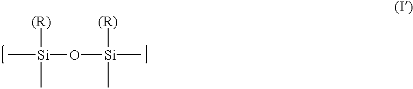

It is preferred that the image-receiving layer is prepared by coating a dispersion further containing gelatin and a gelatin hardening compound.

The gelatin for use in the present invention is a kind of derived proteins and there is no particular limitation on gelatin as far as it is called gelatin produced from collagen. The gelatin is preferably light-colored, transparent, tasteless and odorless. Further, gelatin for a photographic emulsion is preferably used because its physical properties, for example, viscosity of a resulting aqueous solution and jelly strength of gel are maintained within the constant ranges.

By using gelatin in combination with the binder resin for the image-receiving layer, dispersion of the components for the image-receiving layer becomes easy, and uniform dispersion of the inorganic particles is further accelerated. As a result, the film strength of the image-receiving layer is improved, the smoothness of the surface of the image-receiving layer is controlled in a finely uneven state, and adhesion of the image in the image area and hydrophilicity in the non-image area are more improved.

A ratio of the hydrophilic resin modified with a silyl functional group represented by formula (I) to gelatin is preferably from 90/10 to 10/90 by weight, and more preferably from 70/30 to 30/70 by weight.

By the use of gelatin hardening compound in combination, the image-receiving layer is hardened and the water resistance of the layer is further improved.

Conventionally known gelatin hardening compounds can be used in the present invention. Examples of the gelatin hardening compound are described, for example, in T. H. James, The Theory of the Photographic Processes, Chap. 2, Section III, Macmillan Publishing Co., Inc. (1977), and Research Disclosure, No. 17643, p. 26 (December, 1970).

Preferred examples of the gelatin hardening compound include dialdehydes (e.g., succinaldehyde, glutaraldehyde, or adipoaldehyde), diketones (e.g., 2,3-butanedione, 2,5-hexanedione, 3-hexene-2,5-dione or 1,2-cyclopentanedione), and active olefin compounds having two or more double bonds and electron attractive groups bonded adjacent to the double bonds.

The gelatin hardening compound is more preferably a compound having two or more double bond groups represented by formula (II) shown below in its molecule.

CH₂═CH—W— (II)

wherein W represents —OSO₂—, —SO₂—, —CONR¹— or —SO₂NR¹— (wherein R¹ represents a hydrogen atom or an aliphatic group having from 1 to 8 carbon atoms).

In formula (II), R¹ preferably represents a hydrogen atom or an alkyl group having from 1 to 6 carbon atoms which may be substituted (e.g., methyl, ethyl, propyl, butyl, methylol, 2-chloroethyl, 2-hydroxyethyl, 2-hydroxypropyl, 2-carboxyethyl or 3-methoxypropyl). In formula (II), W preferably represents —SO₂—.

Specific examples of the gelatin hardening compound include resorcinol bis(vinylsulfonate), 4,6-bis(vinylsulfonyl)-m-xylene, bis(vinylsulfonylalkyl)ether, bis(vinylsulfonylalkyl)amine, 1,3,5-tris(vinylsulfonyl)-hexahydro-s-triazine, 1,3,5-triacryloylhexahydro-s-triazine, diacrylamide, 1,3-bis(acryloyl)urea and N,N′-bismaleimides.

The gelatin hardening compound is preferably used in an amount of from 0.5 to 20 parts by weight, and more preferably from 0.8 to 10 parts by weight, per 100 parts by weight of the gelatin. In such a range, the resulting image-receiving layer maintains sufficient film strength and exhibits excellent water resistance without injuring the hydrophilicity of the image-receiving layer.

In the image-receiving layer according to the present invention, a ratio of the inorganic pigment to the hydrophilic resin (including gelatin) is preferably from 85/15 to 50/50 by weight, and more preferably from 85/15 to 60/40 by weight. Within such a range, the effects, e.g., film strength, prevention of the adhesion of printing ink in the non-image area, and adhesion of the image in the image area (printing durability of printing plate) can be efficiently obtained.

The above-described image-receiving layer is specifically disclosed in JP-A-10-359383.

In another preferred embodiment of the present invention, the image-receiving layer contains at least one kind of particle selected from a metal oxide hydrate particle, a metal oxide particle and a double oxide particle each having an average particle diameter of from 0.01 to 5 μm and being composed of atoms having a Pauling ionicity rate of not less than 0.2 between the atoms and a binder resin comprising a complex of a resin containing a siloxane bond wherein a silicon atom is connected with an oxygen atom and an organic polymer containing a group capable of forming a hydrogen bond with the resin containing a siloxane bond.

The metal oxide hydrate, metal oxide and double oxide may be any compounds as far as they comprise atoms having the Pauling ionicity rate of not less than 0.2, and more preferably not less than 0.3. The Pauling ionicity rate used herein is described, for example, in Ceramic Zairyogaku (Study of Ceramic Materials), Kaibundo Co. (1990) and Daigakuin Mukikagaku (Inorganic Chemistry—Postgraduate Course), First Vol., Kodansha Co. (1992).

Specifically, the double oxide means a compound in which the presence of a group ion as an oxyacid is not recognized among compounds of higher order comprising two or more oxides (in some cases, double oxides comprising three or more oxides are specifically called compound oxides). The double oxide for use in the present invention contains at least one metallic atom selected from Mg, Al, Si, Ti, Zr, V, Sn, Cr, Mo, W and Nb, and contains as other atoms, one or more metallic atoms selected from Li, Ca, Ba, Sr, Bi, Zn, Pb, Co, Mn, Cu, Ni, La and Ge. Double oxide comprising two metallic atoms is preferred.

The metal oxide for use in the present invention contains a metallic atom selected from Mg, Ba, Ge, Sn, Zn, Pb, La, Zr, V, Cr, Mo, W, Mn, Co, Ni and Cu. Any of metal oxides can be used as long as it does not cause a problem with respect to the stability and safety of material. Metal oxide containing a metallic atom selected from Mg, Ge, Sn, Zn, Pb, Zr, V, Cr, W, Ni and Cu is preferred.

The metal oxide hydrate for use in the present invention contains a metallic atom selected from Mg, Al, Zn, Ti, Ge, Co, Zr, Sn, Fe, Cu, Ni, Pb, Pd, Cd, Cr, Ga, Mn, V, Ce and La. Any of metal oxide hydrate can be used as long as it does not cause a problem with respect to the stability and safety of material. Metal oxide hydrate containing a metallic atom selected from Mg, Al, Fe, Ti and Zn is preferred.

The metal oxide hydrate means an oxide hydrate containing the above-described metallic atom and includes those represented by M(O)(OH)ₙ or MₓO_{y}.zH₂O (wherein M represents a metallic atom, and n, m, x and z each represent an integer).

Any of the double oxide, metal oxide and metal oxide hydrate can be used as long as they do not cause a problem with respect to the stability and safety of material. A particle size of the double oxide, metal oxide or metal oxide hydrate particle is preferably from 0.01 to 10 μm, and more preferably from 0.02 to 8 μm in terms of an average particle diameter. At an average particle diameter in such a range, the preferred surface smoothness of the image-receiving layer and the sufficient strength of the image area after the image formation are ensured, and good images are obtained without the occurrence of stain due to printing ink in the non-image area.

The particles of double oxide, metal oxide and metal oxide hydrate can be produced according to conventionally well-known methods as described, for example, in Nihon Kagakukai ed., Jikken Kagaku Koza 9—Mukikagobutsu no Gosei to Seisei (Experimental Chemistry Course 9—Synthesis and Purification of Inorganic Compounds), Maruzen Co., Ltd. (1958), and Kagaku Daijiten Henshu Iinkai ed., Kagaku Daijiten (Encyclopaedia Chimica) 3, pp. 890 to 949, Kyoritsu Shuppan Co. (1963). The particles are also available as commercial products (for example, those manufactured by Kanto Kagaku Co., Ltd. or Wako Pure Chemical Industries Ltd.). Also, they are described, for example, in Shikizai Kyokai ed., Shikizai Handbook (Coloring Material Handbook), p. 250, Asakura Shoten Co. (1989) and Akira Misonoo et al., Toryo.Ganryo (Paints and Pigments), p. 184, The Nikkan Kogyo Shinbun, Ltd. (1960).

The binder resin for use in the image-receiving layer according to the present invention comprises a complex of a resin containing a siloxane bond wherein a silicon atom (Si) is connected with an oxygen atom (hereinafter also referred to as “a siloxane polymer”), and an organic polymer containing a group capable of forming a hydrogen bond with the resin containing a siloxane bond. The term “complex of a siloxane polymer and an organic polymer” means and include both a sol substance and a gel substance.

The siloxane polymer means a polymer mainly containing a bond of “oxygen atom-silicon atom-oxygen atom”. The siloxane polymer preferably contains a hydroxy group in the substituent of the main chain and/or at the terminal of the main chain of the polymer. The siloxane polymer may contain a hydrocarbon group, if desired. Thus, the formation of uniform layer and the adhesion of the image area can be controlled corresponding to the inorganic particles and the organic polymer used in combination.

The siloxane polymer for use in the present invention is preferably a polymer obtained by hydrolysis co-condensation of the silane compound represented by the following formula (III):

(R⁰)ₘSi(Y)₄₋ₘ (III)

wherein R⁰ represents a hydrogen atoms, a hydrocarbon group or a heterocyclic group; Y represents a reactive group; and m represents 0, 1 or 2, provided that the silicon atom is not connected to 3 hydrogen atoms or 4 hydrogen atoms.

The hydrolysis co-condensation is a reaction of repeating hydrolysis and condensation of a reactive group under an acidic condition or basic condition for polymerization to form a hydroxy group. The silane compounds can be used individually or as a mixture of two or more thereof.

The silane compound represented by formula (III) will be described in detail below.

In formula (III), R⁰ preferably represents a hydrogen atom, a straight chain or branched alkyl group having from 1 to 12 carbon atoms (e.g., methyl, ethyl, propyl, butyl, pentyl, hexyl, heptyl, octyl, nonyl, decyl or dodecyl) which may be substituted with one or more substituents including, for example, a halogen atom (e.g., chlorine, fluorine or bromine), a hydroxy group, a thiol group, a carboxy group, a sulfo group, a cyano group, an epoxy group, an —OR′ group (wherein R′ represents a hydrocarbon group, e.g., methyl, ethyl, propyl, butyl, hexyl, heptyl, octyl, decyl, propenyl, butenyl, hexenyl, octenyl, 2-hydroxyethyl, 3-chloropropyl, 2-cyanoethyl, N,N-dimethylaminoethyl, 2-bromoethyl, 2-(2-methoxyethyl)oxyethyl, 2-methoxy-carbonylethyl, 3-carboxypropyl or benzyl), an —OCOR′ group, a —COOR′ group, a —COR′ group, an —N(R″)(R″) group (wherein R″, which may be the same or different, each represent a hydrogen atom or the group same as defined for R′ above), an —NHCONHR′ group, an —NHCOOR′ group, an —Si(R′)₃ group, —CONHR″ group, or an —NHCOR′ group); a straight chain or branched alkenyl group having from 2 to 12 carbon atoms (e.g., vinyl, propenyl, butenyl, pentenyl, hexenyl, octenyl, decenyl or dodecenyl) which may be substituted with one or more substituents selected from the substituents for the alkyl group described above; an aralkyl group having from 7 to 14 carbon atoms (e.g., benzyl, phenethyl, 3-phenylpropyl, naphthylmethyl or 2-naphthylethyl) which may be substituted with one or more substituents selected from the substituents for the alkyl group described above; an alicyclic group having from 5 to 10 carbon atoms (e.g., cyclopentyl, cyclohexyl, 2-cyclohexylethyl, 2-cyclopentylethyl, norbornyl or adamantly) which may be substituted with one or more substituents selected from the substituents for the alkyl group described above; an aryl group having from 6 to 12 carbon atoms (e.g., phenyl or naphthyl) which may be substituted with one or more substituents selected from the substituents for the alkyl group described above; or a heterocyclic group containing at least one atom selected from a nitrogen atom, an oxygen atom and a sulfur atom, which may be condensed (examples of the hetero ring including pyran, furan, thiophene, morpholine, pyrrole, thiazole, oxazole, pyridine, piperidine, pyrrolidone, benzothiazole, benzoxazole, quinoline and tetrahydrofuran) and which may be substituted with one or more substituents selected from the substituents for the alkyl group described above.

In formula (III), the reactive group represented by Y include a hydroxy group, a halogen atom (e.g., fluorine, chlorine, bromine or iodine), —OR², —OCOR³ or —N(R⁴)(R⁵) (wherein R² and R³ each represent a hydrocarbon group, and R⁴ and R⁵, which may be the same or different, each represent a hydrogen atom or a hydrocarbon group).

In the —OR² group, R² represents an aliphatic group having from 1 to 10 carbon atoms which may be substituted (e.g., methyl, ethyl, propyl, butyl, pentyl, hexyl, heptyl, octyl, nonyl, decyl, propenyl, butenyl, heptenyl, hexenyl, octenyl, decenyl, 2-hydroxyethyl, 2-hydroxypropyl, 2-methoxyethyl, 2-(methoxyethyloxy)ethyl, 2-(N,N-diethylamino)ethyl, 2-methoxypropyl, 2-cyanoethyl, 3-methyloxypropyl, 2-chloroethyl, cyclohexyl, cyclopentyl, cyclooctyl, chlorocyclohexyl, methoxycyclohexyl, benzyl, phenethyl, dimethoxybenzyl, methylbenzyl or bromobenzyl).

In the —OCOR³ group, R³ represents an aliphatic group as defined for R² above, or an aromatic group having from 6 to 12 carbon atoms which may be substituted (e.g., the aryl groups as described for R⁰ above).

In the —N(R⁴)(R⁵) group, R⁴ and R⁵, which may be the same or different, each represent a hydrogen atom or an aliphatic group having from 1 to 10 carbon atoms which may be substituted (e.g., the aliphatic groups as described for R² in the —OR² group above). More preferably, the total number of carbon atoms contained in R⁴ and R⁵ is 16 or less.

Y preferably represents a hydroxy group, a halogen atom, an —OR² group, an —OCOR³ group or an —N(R⁴)(R⁵) group.

Specific examples of the silane compound represented by formula (III) include the following compounds, but the present invention should not be construed as being limited thereto:

Methyltrichlorosilane, methyltribromosilane, methyltrimethoxysilane, methyltriethoxysilane, methyltriisopropoxysilane, methyltri(tert-butoxy)silane, ethyltrichlorosilane, ethyltribromosilane, ethyltrimethoxysilane, ethyltriethoxysilane, ethyltriisopropoxysilane, ethyltri(tert-butoxy)silane, n-propyltrichlorosilane, n-propyltribromosilane, n-propyltrimethoxysilane, n-propyltriethoxysilane, n-propyltriisopropoxysilane, n-propyltri(tert-butoxy)silane, n-hexyltrichlorosilane, n-hexyltribromosilane, n-hexyltrimethoxysilane, n-hexyltriethoxysilane, n-hexyltriisopropoxysilane, n-hexyltri(tert-butoxy)silane, n-decyltrichlorosilane, n-decyltribromosilane, n-decyltrimethoxysilane, n-decyltriethoxysilane, n-decyltriisopropoxysilane, n-decyltri(tert-butoxysilane), n-octadecyltrichlorosilane, n-octadecyltribromosilane, n-octadecyltrimethoxysilane, n-octadecyltriethoxysilane, n-octadecyltriisopropoxysilane, n-octadecyltri(tert-butoxy)silane, phenyltrichlorosilane, phenyltribromosilane, phenyltrimethoxysilane, phenyltriethoxysilane, phenyltriisopropoxysilane, phenyltri(tert-butoxy)silane, tetrachlorosilane, tetrabromosilane, tetramethoxysilane, tetraethoxysilane, tetraisopropoxysilane, tetrabutoxysilane, dimethoxydiethoxysilane, dimethyldichlorosilane, dimethyldibromosilane, dimethyldimethoxysilane, dimethyldiethoxysilane, diphenyldichlorosilane, diphenyldibromosilane, diphenyldimethoxysilane, diphenyldiethoxysilane, phenylmethyldichlorosilane, phenylmethyldibromosilane, phenylmethyldimethoxysilane, phenylmethyldiethoxysilane, triethoxyhydrosilane, tribromohydrosilane, trimethoxyhydrosilane, triisopropoxyhydrosilane, tri(tert-butoxy)hydrosilane, vinyltrichlorosilane, vinyltribromosilane, vinyltrimethoxysilane, vinyltriethoxysilane, vinyltriisopropoxysilane, vinyltri(tert-butoxy)silane, trifluoropropyltrichlorosilane, trifluoropropyltribromosilane, trifluoropropyltrimethoxysilane, trifluoropropyltriethoxysilane, trifluoropropyltriisopropoxysilane, trifluoropropyltri(tert-butoxy)silane, γ-glycidoxypropylmethyldimethoxysilane, γ-glycidoxypropylmethyldiethoxysilane, γ-glycidoxypropyltrimethoxysilane, γ-glycidoxypropyltriethoxysilane, γ-glycidoxypropyltriisopropoxysilane, γ-glycidoxypropyltri(tert-butoxy)silane, γ-methacryloxypropylmethyldimethoxysilane, γ-methacryloxypropylmethyldiethoxysilane, γ-methacryloxypropyltrimethoxysilane, γ-methacryloxypropyltriisopropoxysilane, γ-methacryloxypropyltri(tert-butoxy)silane, γ-aminopropylmethyldimethoxysilane, γ-aminopropylmethyldiethoxysilane, γ-aminopropyltrimethoxysilane, γ-aminopropyltriethoxysilane, γ-aminopropyltriisopropoxysilane, γ-aminopropyltri(tert-butoxy)silane, γ-mercaptopropylmethyldimethoxysilane, γ-mercaptopropylmethyldiethoxysilane, γ-mercaptopropyltrimethoxysilane, γ-mercaptopropyltriethoxysilane, γ-mercaptopropyltriisopropoxysilane, γ-mercaptopropyltri(tert-butoxy)silane, β-(3,4-epoxycyclohexyl)ethyltrimethoxysilane, and β-(3,4-epoxycyclohexyl)ethyltriethoxysilane.

In combination with the silane compound represented by formula (III) which is used for the formation of the image-receiving layer, a metallic compound capable of forming film by a sol-gel method, for example, a Ti, Zn, Sn, Zr or Al compound can be used.

Specific examples of the metallic compound used in combination include Ti(OR⁶)₄ (wherein R⁶ represents an alkyl group, e.g., methyl, ethyl, propyl, butyl, pentyl or hexyl), TiCl₄, Zn(OR⁶)₂, Zn(CH₃COCHCOCH₃)₂, Sn(OR⁶)₄, Sn(CH₃COCHCOCH₃)₄, Sn(OCOR⁶)₄, SnCl₄, Zr(OR⁶)₄, Zr(CH₃COCHCOCH₃)₄ and Al(OR⁶)₃.

Now, the organic polymer for use in the present invention will be described in more detail below.

The organic polymer contains a group capable of forming a hydrogen bond with the resin containing a siloxane bond. The group capable of forming a hydrogen bond with the resin containing a siloxane bond (hereinafter also referred to as a specific bond-forming group) preferably includes an amido bond (including a carbonamido bond and a sulfonamido bond), a urethane bond, a ureido bond and a hydroxy group.

The organic polymer contains at least one specific bond-forming group in the main chain and/or the side chain thereof as a repeating unit component. The organic polymer preferably includes a polymer containing, as a repeating unit component, a component having at least one bond selected from —N(R¹¹)CO—, —N(R¹¹)S₂O—, —NHCONH— and —NHCOO— in the main chain or side chain thereof, and a polymer containing, as a repeating unit component, a component having a hydroxy group. In the above-described amido bonds, R¹¹ represents a hydrogen atom or an organic residue, and the organic residue includes the hydrocarbon group and heterocyclic group represented by R⁰ in formula (I).

The organic polymer containing the specific bond-forming group in its main chain according to the present invention includes an amide resin having the —N(R¹¹)CO— or —N(R¹¹)SO₂— bond, a ureido resin having the —NHCONH— bond and a urethane resin having the —NHCOO bond.

As diamines and dicarboxylic acids used for preparation of the amide resins, diisocyanates used for preparation of the ureido resins and diols used for preparation of the urethane resins, compounds described, for example, in Kobunshi Gakkai ed., Kobunshi Data Handbook——Kisohen—(Polymer Data Handbook—Fundamental Volume—), Chapter I, Baifukan Co., Ltd. (1986), Shinzo Yamashita and Tosuke Kaneko ed., Kakyozai Handbook (Handbook of Cross-linking Agents), Taiseisha Co., Ltd. (1981).

Other examples of the polymer containing the amido bond include a polymer containing a repeating unit represented by formula (IV) shown below, an N-acylated polyalkyleneimine, and polyvinylpyrrolidone and a derivative thereof.

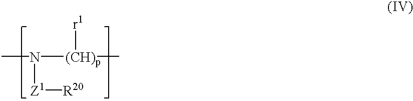

wherein, Z¹ represents —CO—, SO₂— or —CS—; R²⁰ represents a hydrogen atom, a hydrocarbon group or a heterocyclic group (the hydrocarbon group and heterocyclic group having the same meanings as those defined for R⁰ in formula (III), respectively); r¹ represents hydrogen atom or an alkyl group having from 1 to 6 carbon atoms (e.g., methyl, ethyl, propyl, butyl, pentyl or hexyl), r¹s may be the same or different; and p represents an integer of 2 or 3.

Among the polymers containing a repeating unit represented by formula (IV), a polymer wherein Z¹ represents —CO— and p is 2 can be obtained by ring-opening polymerization of oxazoline which may be substituted in the presence of a catalyst. The catalyst which can be used includes a sulfuric ester or sulfonic ester (e.g., dimethyl sulfate or an alkyl p-toluenesulfonate), an alkyl halide (e.g., an alkyl iodide such as methyl iodide), a fluorinated metallic compound of Friedel-Crafts catalyst, and an acid (e.g., sulfuric acid, hydrogen iodide or p-toluenesulfonic acid) or an oxazolinium salt thereof formed from the acid and oxazoline.

The polymer may be a homopolymer or a copolymer. The polymer also includes a graft polymer containing the units derived from oxazoline in its graft portion.

Specific examples of the oxazoline include 2-oxazoline, 2-methyl-2-oxazoline, 2-ethyl-2-oxazoline, 2-propyl-2-oxazoline, 2-isopropyl-2-oxazoline, 2-butyl-2-oxazoline, 2-dichloromethyl-2-oxazoline, 2-trichloromethyl-2-oxazoline, 2-pentafluoroethyl-2-oxazoline, 2-phenyl-2-oxazoline, 2-methoxycarbonylethyl-2-oxazoline, 2-(4-methylphenyl)-2-oxazoline, and 2-(4-chlorophenyl)-2-oxazoline. Preferred examples of the oxazoline include 2-oxazoline, 2-methyl-2-oxazoline, 2-ethyl-2-oxazoline. The oxazolines may be employed individually or as a mixture of two or more thereof.

Other polymers containing a repeating unit represented by formula (IV) are also obtained in the same manner as described above except for using thiazoline, 4,5-dihydro-1,3-oxazine or 4,5-dihydro-1,3-thiazine in place of the oxazoline.

The N-acylated polyalkyleneimine includes a carboxylic amide compound containing an —N(CO—R²²)— bond obtained by a polymer reaction of polyalkyleneimine with a carboxylic halide and a sulfonamide compound containing an —N(SO₂—R²²)— bond obtained by a polymer reaction of polyalkyleneimine with a sulfonyl halide. In the above amido bond, R²² has the same meaning as R²⁰ defined in formula (IV).

The organic polymer containing the specific bond-forming group in the side chain thereof according to the present invention includes a polymer containing as the main component, a component having at least one bond selected from the specific bond-forming groups.

Specific examples of the component having the specific bond-forming group include repeating units derived from acrylamide, methacrylamide, crotonamide and vinyl acetamide, and the repeating units shown below, but the present invention should not be construed as being limited thereto.

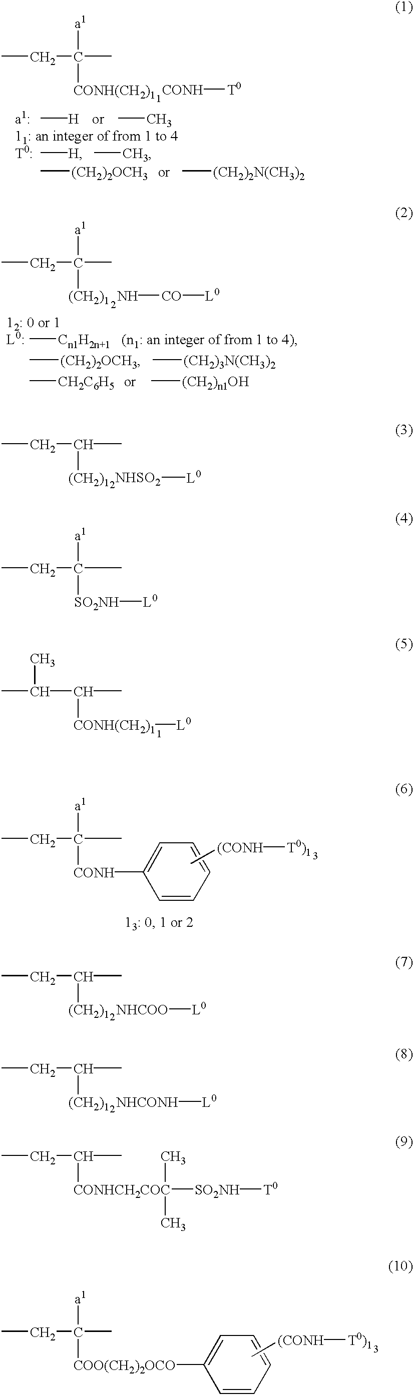

The organic polymer containing a hydroxyl group may be any of natural water-soluble polymers, semisynthetic water-soluble polymers, and synthetic polymers, and specific examples thereof include those described, for example, in Munio Kotake supervised, Dai Yukikagaku (Grand Organic Chemistry), 19: Tennen Kobunshi Kagobutsu (Natural Polymer Compounds) I, Asakura Shoten Co. (1960), Keiei Kaihatsu Center Publishing Division ed, Suiyosei Kobunshi.Mizubunsangata Jushi Sogo Gijutsu Shiryoshu (Water-Soluble Polymers.Aqueous Dispersion Type Resins, Collective Technical Data, Keiei Kaihatsu Center Publishing Division (1981), Shinji Nagatomo, Shin Suiyosei Polymer no Oyo to Shijo (New Application and Market of Water-Soluble Polymers), CMC Publishing Co. (1988), Kinosei Cellulose no Kaihatsu (Development of Functional Cellulose), CMC Publishing Co. (1985).

Specific examples of the natural and semisynthetic polymers include cellulose, cellulose derivatives (for example, cellulose esters, e.g., cellulose nitrate, cellulose sulfate, cellulose acetate, cellulose propionate, cellulose succinate, cellulose butyrate, cellulose acetate succinate, cellulose acetate butyrate or cellulose acetate phthalate; and cellulose ethers, e g., methyl cellulose, ethyl cellulose, cyanoethyl cellulose, carboxymethyl cellulose, hydroxyethyl cellulose, hydroxypropyl cellulose, ethylhydroxyethyl cellulose, hydroxypropylmethyl cellulose or carboxymethylhydroxyethyl cellulose), starch, starch derivatives (e.g., oxidized starch, esterified starches including those esterified with an acid, e.g., nitric acid, sulfuric acid, phosphoric acid, acetic acid, propionic acid, butyric acid or succinic acid; and etherified starches, e.g., methylated starch, ethylated starch, cyanoethylated starch, hydroxyalkylated starch or carboxymethylated starch), alginic acid, pectin, carrageenan, tamarind gum, natural rubber (e.g., gum arabic, guar gum, locust bean gum, tragacanth gum or xanthane gum), pullulan, dextran, casein, gelatin, chitin and chitosan.

Examples of synthetic polymer include polyvinyl alcohol, polyalkylene glycol (e.g., polyethylene glycol, polypropylene glycol or ethylene glycol-propylene glycol copolymers), allyl alcohol copolymers, acrylate copolymers, methacrylate copolymers, homopolymers or copolymers of acrylate or methacrylate containing at least one hydroxy group (examples of the ester portions including 2-hydroxyethyl, 3-hydroxypropyl, 2,3-dihydroxypropyl, 3-hydroxy-2-hydroxymethyl-2-methylpropyl, 3-hydroxy-2,2-di(hydroxymethyl)propyl, polyoxyethylene and polyoxypropylene groups), and homopolymers or copolymers of N-substituted acrylamide or methacrylamide containing at least one hydroxy group (examples of the N-substituent including monomethylol, 2-hydroxyethyl, 3-hydroxypropyl, 1,1-bis(hydroxymethyl)ethyl and 2,3,4,5,6-pentahydroxypentyl groups). However, the synthetic polymer is not particularly limited as far as it contains at least one hydroxy group in a side chain substituent of the repeating unit thereof.

A weight average molecular weight of the organic polymer for use in the image-receiving layer is preferably from 10³ to 10⁶, and more preferably from 5×10³ to 4×10⁵.

In the complex comprising a siloxane polymer and an organic polymer, a ratio of the siloxane polymer to the organic polymer can be selected from a wide range, but the weight ratio of the siloxane polymer/organic polymer is preferably from 10/90 to 90/10, more preferably from 20/80 to 80/20. In such a range, the film strength of the image-receiving layer and the water resistance of the image-receiving layer against dampening water at the time of printing can be improved.

It is presumed that the binder resin comprising the above-described complex forms uniform organic/inorganic hybrid by the function of the hydrogen bonds generated between the hydroxy groups of the siloxane polymer produced by the hydrolysis co-condensation of the silane compounds described above and the specific bond-forming groups in the organic polymer, and is microscopically homogeneous without causing phase separation, thus the affinity between the siloxane polymer and the organic polymer is well maintained. Further, when the hydrocarbon group is included in the siloxane polymer, the affinity between the siloxane polymer and the organic polymer is further improved due to the presence of the hydrocarbon group. The complex according to the present invention is superior in a film-forming property.

The resins of the organic/inorganic polymer complex can be produced easily by subjecting the silane compound to hydrolysis co-condensation and mixing with the organic polymer, alternatively by performing the hydrolysis co-condensation of the silane compound in the presence of the organic polymer.

Preferably, the organic/inorganic polymer complex can be obtained by the hydrolysis co-condensation of the silane compound by a sol-gel method in the presence of the organic polymer. In the organic/inorganic polymer complex formed, the organic polymer is uniformly dispersed in a matrix (that is, three-dimensional micro-network structure of the inorganic metal oxide) of gel produced by the hydrolysis co-condensation of the silane compound.

The sol-gel method described above as preferred method can be performed by conventionally known methods. The details of the sol-gel method are described, for example, in Sol-Gel Ho ni yoru Hakumaku Coating Gijutsu (Thin Film Coating Technology by Sol-Gel Method, Gijutsujoho Kyokai (1995), Sumio Sakibana, Sol-Gel Ho no Kagaku (Science of Sol-Gel Method), Agne Shofu-Sha (1988), and Seki Hirashima, Saishin Sol-Gel Ho ni yoru Kino-Sei Hakumaku Sakusei Gijutsu (Latest Technology of Functional Thin Film by Sol-Gel Method), Sogo Gijutsu Center (1992).

An aqueous solvent is preferably used in the coating solution for the image-receiving layer, and a water-soluble solvent may be used in combination for preventing the occurrence of precipitation during the preparation of coating solution to obtain a homogeneous solution. Examples of water-soluble solvent include alcohols (e.g., methanol, ethanol, propyl alcohol, ethylene glycol, diethylene glycol, propylene glycol, dipropylene glycol, ethylene glycol monomethyl ether, propylene glycol monomethyl ether or ethylene glycol monoethyl ether), ethers (e.g., tetrahydrofuran, ethylene glycol dimethyl ether, propylene glycol dimethyl ether or tetrahydropyran), ketones (e.g., acetone, methyl ethyl ketone or acetylacetone), esters (e.g., methyl acetate or ethylene glycol monomethyl monoacetate) and amides (e.g., formamide, N-methylformamide, pyrrolidone or N-methylpyrrolidone), and the solvent may be used individually or two or more solvents may be used in combination.

Further, it is preferred to use an acidic or basic catalyst in order to accelerate the hydrolysis and co-condensation reaction of the silane compound represented by formula (III).

As the catalyst, an acidic or basic compound may be used as it is, or may be dissolved in water or a solvent, for example, water or alcohol (hereinafter referred to as acidic catalyst or basic catalyst). The concentration of catalyst is not particularly restricted but when the concentration is high, hydrolysis and co-condensation reaction are liable to become fast. However, when the basic catalyst in high concentration is used, a precipitate is formed in some cases in a sol solution, therefore, the concentration of basic catalyst is preferably 1N or less (calculated in terms of the concentration in an aqueous solution).

The kind of acidic catalyst or basic catalyst is not particularly restricted. When a catalyst must be used in a high concentration, however, a catalyst constituted of the elements which hardly remain in the catalyst crystal grains after sintering is preferred. Specifically, examples of the acidic catalyst include a hydrogen halide, e.g., hydrochloric acid, nitric acid, sulfuric acid, sulfurous acid, hydrogen sulfide, perchloric acid, hydrogen peroxide, carbonic acid, a carboxylic acid, e.g., formic acid or acetic acid, a substituted carboxylic acid represented by RCOOH wherein R is substituted with another element or substituent, and a sulfonic acid, e.g., benzenesulfonic acid, and examples of the basic catalyst include an ammoniacal base, e g., aqueous ammonia, and an amine, e.g., ethylamine or aniline.

The image-receiving layer may contain other components in addition to the above-described components.

To the image-receiving layer, a cross-linking agent may be added for further increasing the film-strength thereof. The cross-linking agent for use in the image-receiving layer includes compounds ordinarily used as cross-linking agents. Specifically, compounds as described, for example, in Shinzo Yamashita and Tosuke Kaneko ed., Kakyozai Handbook (Handbook of Cross-linking Agents), Taiseisha Co., Ltd. (1981) and Kobunshi Gakkai ed., Kobunshi Data Handbook—Kisohen—(Polymer Data Handbook—Fundamental Volume—), Baifukan Co., Ltd. (1986) are used.

Specific examples of the cross-linking agent which can be used include ammonium chloride, a metal ion, an organic peroxide, a polyisocyanate compound (e.g., toluylene diisocyanate, diphenylmethane diisocyanate, triphenylmethane triisocyanate, polymethylene phenylisocyanate, hexamethylene diisocyanate, isophorone diisocyanate or a high molecular polyisocyanate), a polyol compound (e.g., 1,4-butanediol, polyoxypropylene glycol, polyoxyethylene glycol or 1,1,1-trimethylolpropane), a polyamine compound (e.g., ethylenediamine, γ-hydroxypropylated ethylenediamine, phenylenediamine, hexamethylenediamine, N-aminoethylpiperazine or a modified aliphatic polyamine), a polyepoxy group-containing compound and an epoxy resin (e.g., compounds as described in Hiroshi Kakiuchi, Shin Epoxy Jushi (New Epoxy Resins), Shokodo (1985) and Kuniyuki Hashimoto, Epoxy Jushi (Epoxy Resins), The Nikkan Kogyo Shinbun, Ltd. (1969)), a melamine resin (e.g., compounds as described in Ichiro Miwa and Hideo Matsunaga, Urea.Melamine Jushi (Urea.Melamine Resins), The Nikkan Kogyo Shinbun, Ltd. (1969)), and a poly(meth)acrylate compound (e.g., compounds as described in Makoto Ogawara, Takeo Saegusa and Toshinobu Higashimura ed, Oligomer (Oligomers), Kodansha Ltd. (1976) and Eizo Omori, Kinousei Acryl Kei Jushi (Functional Acrylic Resins), Techno System (1985)).

A coating solution for the image-receiving layer is coated on a water-resistant support using any of conventionally known coating methods, and dried to form the image-receiving layer.

The thickness of image-receiving layer formed is preferably from 0.2 to 10 μm, and more preferably from 0.5 to 8 μm. At a thickness in such a range, the layer formed can have a uniform thickness and sufficient film-strength.

On the other hand, as the image-receiving layer which is hydrophilized by oil-desensitizing treatment, for example, a layer comprising zinc oxide and a hydrophobic binder can be exemplified.

Zinc oxide for use in the image-receiving layer may be any of products commercially available under the name of zinc oxide, zinc flower, wet zinc flower or active zinc flower, as described in Nihon Ganryo Gijutsu Kyokai ed., Shinban Ganryo Binran (Pigment Handbook, New Edition), p. 319, Seibundo Co. (1968).

Specifically, zinc oxides are classified into French method (indirect method) and American method (direct method) as dry system, and wet system, and include those available from, e.g., Seido Kagaku Co., Ltd., Sakai Chemical Industry Co., Ltd., Hakusui Kagaku Co., Ltd., Honjo Chemical Co., Ltd., Toho Aen Co., Ltd., and Mitsui Metallic Industry Co., Ltd.

Examples of the resin used as a hydrophobic binder include styrene copolymers, methacrylate copolymers, acrylate copolymers, vinyl acetate copolymers, polyvinyl butyral, alkyd resins, epoxy resins, epoxy ester resins, polyester resins and polyurethane resins. The resins may be used individually or in combination of two or more thereof.

A content of the resin in the image-receiving layer is preferably from 9/91 to 20/80 by weight ratio in terms of the resin/zinc oxide.

For the oil-desensitizing of zinc oxide, various oil-desensitizing solutions are known, for example, a cyan compound-containing oil-desensitizing solution containing ferrocyanate or ferricyanate as the main component, a cyan-free oil-desensitizing solution containing ammine cobalt complex, phytic acid and a derivative thereof, or a guanidine derivative as the main component, an oil-desensitizing solution containing an inorganic or organic acid which forms chelate with a zinc ion as the main component, and an oil-desensitizing solution containing a water-soluble polymer.

Examples of the cyan compound-containing oil-desensitizing solution include those described in JP-B-44-9045, JP-B-46-39403, JP-A-52-76101, JP-A-57-107889 and JP-A-54-117201.

Any of conventionally known ink jet recording systems can be employed for the image formation. However, the recording system using oily ink is preferable in view of drying and fixing properties of ink image and less occurrence of ink clogging, and an electrostatic type (or an electrostatic attractive type) ink jet recording system is preferable, because such a system hardly causes blur of image. A solid jet type ink jet recording system using hot-melt ink is also preferably used.

For the ink jet recording system of on-demand type utilizing static electricity, a method called an electrostatically accelerating type ink jet or slit jet as described, for example, in Susumu Ichinose and Yuuji Ooba, Denshi Tsushin Gakkai Ronbunshi, Vol. J66-C, No. 1, p. 47 (1983) and Tadayoshi Oono and Mamoru Mizuguchi, Gazo Denshi Gakkaishi, Vol. 10, No. 3, p. 157 (1981) can be employed. Such an ink jet recording system is also described more specifically, for example, in JP-A-56-170, JP-A-56-4467 and JP-A-57-151374.

According to the method, ink is supplied from an ink tank to a slit-shaped ink chamber having many electrodes arranged in inner surface of a slit-shaped ink retaining part and when a high voltage is selectively applied to each electrode, the ink neighboring to the electrode is discharged on a recording paper closely positioned against the slits, thereby conducting recording.

A method, which dose not use such a slit-shaped recording head, is also used. In JP-A-61-211048, there is described a method in which pores of a film-like ink retainer having plural pores are filled with ink and the ink in the pores is transferred to a recording paper by applying selectively a voltage to the ink using a multi-needle electrode.

The oily ink to be used is a dispersion comprising hydrophobic resin particles, which are solid at least at normal temperature (i.e., from 15 to 35° C.), dispersed in a non-aqueous solvent preferably having an electric resistance of 10⁹ Ω·cm or more and a dielectric constant of 3.5 or less as a dispersion medium. By using such a non-aqueous solvent as the dispersion medium, the electric resistance of the oily ink is properly controlled, thus the ejection of the oily ink by the action of an electrical field can be effected, and as a result, the image quality is improved. In addition, the use of the above-described resin particles enhances the affinity with the image-receiving layer, and as a result, high quality images can be obtained as well as printing durability of the resulting printing plate is improved. Specific examples of the oily ink include those disclosed, e.g., in JP-A-10-203039 and JP-A-10-250254.

For the solid jet type ink jet recording system, commercially available printing systems, for example, Solid Inkjet Platemaker SJ₀₂A (manufactured by Hitachi Koki Co., Ltd.) and MP-1200Pro (manufactured by Dynic Co., Ltd.) are employed.

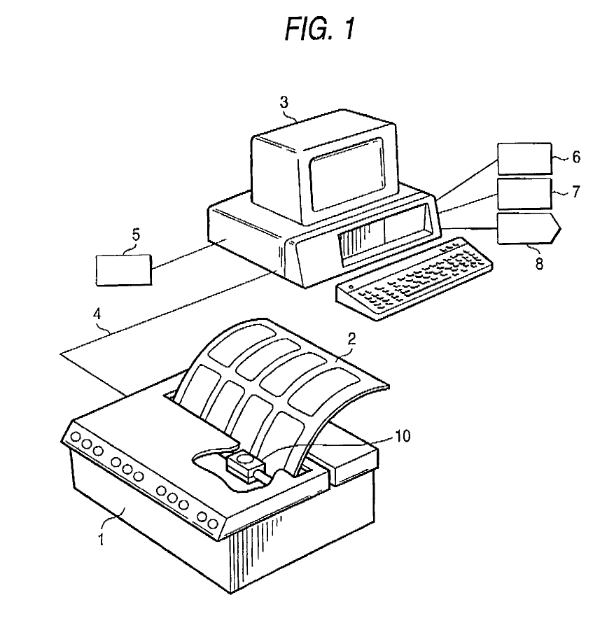

A method for forming an image on the lithographic printing plate precursor according to the present invention using an ink jet recording system is described in more detail below with reference to FIG. 1 to FIG. 3.

An apparatus system shown in FIG. 1 comprises an ink jet recording device 1 wherein oily ink is used.

As shown in FIG. 1, pattern information of images (figures and letters) to be formed on a lithographic printing plate precursor (also referred to as “master” hereinafter) 2 is first supplied from an information supply source such as a computer 3 to the ink jet recording device 1 using oily ink through a transmission means such as a bus 4. An ink jet recording head 10 of the recording device 1 stores oily ink inside. When the master 2 is passed through the ink jet recording device 1, the head 10 ejects minute droplets of the ink onto the master 2 in accordance with the above described information, whereby the ink is attached to the master 2 in the above described pattern. Thus, the image formation on the master 2 (i.e., plate-making) is conducted, whereby the lithographic printing plate precursor having the images thereon is obtained.

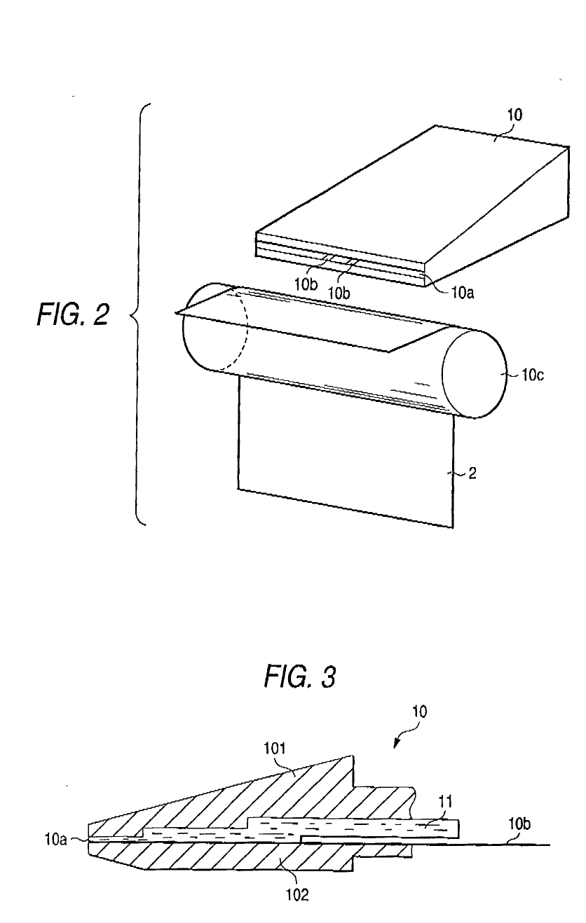

One example of the ink jet recording device as shown in the apparatus system of FIG. 1 is depicted in FIG. 2 and FIG. 3, respectively. In FIG. 2 and FIG. 3, members common to the members in FIG. 1 are designated using the same symbols, respectively.

FIG. 2 is a schematic view showing the main part of the ink jet recording device, and FIG. 3 is a partially cross sectional view of the head.

As shown in FIG. 3, the head 10 installed in the ink jet recording device has a slit between an upper unit 101 and a lower unit 102, a leading edge thereof forms an ejection slit 10a. Further, an ejection electrode 10b is arranged in the slit, and the interior of the slit is filled with oily ink 11.

To the ejection electrode 10b of the head 10, a voltage is applied in accordance with digital signals from the pattern information of image. As shown in FIG. 2, a counter electrode 10c is arranged so as to face with the ejection electrode 10b, and the master 2 is positioned on the counter electrode 10c. By the application of the voltage, a circuit is formed between the ejection electrode 10b and the counter electrode 10c, and the oily ink 11 is ejected from the ejection slit 10a of the head 10, thereby forming an image on the master 2 positioned on the counter electrode 10c.

With respect to the width of ejection electrode 10b, it is preferred for the leading edge thereof to be as narrow as possible in order to form an image of high quality.

For instance, print of 40 μm-dot can be formed on the master 2 by filling the head 10 as shown in FIG. 3 with the oily ink, disposing the ejection electrode 10b having a leading edge having a width of 20 μm and the counter electrode 10c so as to face with each other at a distance of 1.5 mm and applying a voltage of 3 KV for 0.1 millisecond between these two electrodes.

The master after plate-making obtained by forming an image by the ink jet recording system using oily ink on the lithographic printing plate as described above is subjected to a surface treatment with an oil-desensitizing solution to oil-desensitize the non-image area, to prepare a printing plate.

The present invention will be described in greater detail with reference to the following examples, but the present invention should not be construed as being limited thereto.

### EXAMPLE 1

On a polyethylene terephthalate film (Trancy manufactured by Fuji Photo Film Co., Ltd.) having a thickness of 120 μm was coated a coating composition for inter layer shown below so as to have a coating amount of 3 g/m² after drying, followed by drying.

<Coating Composition for Inter Layer>

To the components shown below was added water so as to have a solid concentration of 25% and the resulting mixture was dispersed using a homogenizer (manufactured by Toyo Seiki Co., Ltd.) at 7,000 rpm for 20 minutes to prepare a coating composition for inter layer.

| | |
|---|---|
| Cray (50% aqueous dispersion) | 30 g |
| Colloidal silica (20% aqueous solution) | 70 g |
| (Snowtex C manufactured by Nissan | |
| Chemical Industries, Ltd.; average | |
| particle diameter: 20 nm) | |
| SBR latex (solid content: 50%; Tg: 25° C.) | 36 g |
| Melamine resin (solid content: 80%; | 4 g |
| Sumirez Resin SR-613) | |

Then, a coating composition for image-receiving layer shown below was coated on the inter layer so as to have a coating amount of 7 g/m² after drying, followed by drying to prepare a lithographic printing plate precursor according to the present invention.

<Coating Composition for Image-Receiving Layer>

The components shown below were dispersed together with glass beads in a paint shaker (manufactured by Toyo Seiki Co., Ltd.) for 60 minutes. The glass beads were removed by filtration to obtain a coating composition for image-receiving layer.

| | | |
|---|---|---|
| Silica (Silysia 430 manufactured by Fuji- | 26 | g |
| Silysia Chemical Co., Ltd.; average | | |
| particle diameter: 2.5 μm) | | |
| Colloidal silica (20% aqueous solution) | 70 | g |
| (Snowtex C manufactured by Nissan | | |
| Chemical Industries, Ltd; average | | |
| particle diameter: 20 nm) | | |
| Gelatin (10% aqueous solution) | 44 | g |
| Trialkoxysilyl-modified polyvinyl alcohol | 73 | g |
| (10% aqueous solution) (R-1130 | | |
| manufactured by Kuraray Co., Ltd.; | | |
| modification amount: 0.3% by mole) | | |
| Fluorinated alkylester (FC430 | 0.24 | g |
| manufactured by 3M Co.) | | |
| Hardening compound (K-1) | 1.20 | g |
| CH₂═CHSO₂CH₂CONH(CH₂)₃NHCOCH₂SO₂CH═CH₂ | | |
| Water | 106 | g |

A servo plotter (DA8400 manufactured by Graphtech Co.), which is able to draw in accordance with an output from a personal computer, was modified so that an ink ejection head as shown in FIG. 2 was mounted on a pen plotter section, and the lithographic printing plate precursor described above was placed on a counter electrode positioned at a distance of 1.5 mm from the ink ejection head. Ink jet printing was performed on the lithographic printing plate precursor using Oily Ink (IK-1) described below to conduct plate-making. At the plate-making, the inter layer provided just under the image-receiving layer of the printing plate precursor was connected electrically to the counter electrode by silver paste.

Then, the printing plate precursor having the ink image thereon was heated by means of a Ricoh Fuser Model 592 (manufactured by Ricoh Co., Ltd.) so as to control the surface temperature of the ink image to 130° C. for 20 seconds, thereby sufficiently fixing the image area.

<Preparation of Oily Ink (IK-1)>

(Production of Resin Particle)

A mixed solution of 10 g of a dispersion stabilizing resin having the structure shown below and 290 g of Isopar G was heated to a temperature of 70° C. under nitrogen gas stream with stirring. To the solution was added a mixture of 65 g of methyl acrylate, 30 g of methyl methacrylate, 5 g of acrylic acid and 1.5 g of 2,2′-azobis(isovaleronitrile) (abbreviated as AIVN) over a period of 60 minutes, followed by reacting for 2 hours. Then, 1.0 g AIVN was added to the reaction mixture and the temperature was adjusted at 75° C., followed by reacting for 2 hours. Further, 0.8 g of 2,2′-azobis(isobutyronitrile) was added to the reaction mixture and the temperature was adjusted at 80° C., followed by reacting for 3 hours.

Dispersion Stabilizing Resin

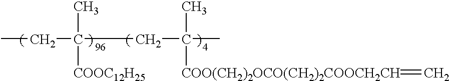

Mw 5×10⁴ (weight ratio)

To the reaction mixture was added 5 g of dye (Victoria Blue B) and the mixture was heated at a temperature of 90° C. for 4 hours to stain resin grains. After cooling the reaction mixture, it was passed through a nylon cloth of 200 meshes. The resulting blue dispersion was a latex of good monodispersity having a polymerization rate of 99.5% and an average particle diameter of 0.38 μm.

### Comparative Example 1

A lithographic printing plate precursor was prepared according to the coating and drying of image-receiving layer and the drawing of image in the same manner as in Example 1, except for using a coating composition for inter layer prepared by mixing the components shown below and adding water so as to have a solid concentration of 25%.

| | |
|---|---|
| Colloidal silica (20% aqueous solution) | 5 g |
| (Snowtex C manufactured by Nissan | |
| Chemical Industries, Ltd.; average | |
| particle diameter: 20 nm) | |
| SBR latex (solid content: 50%; Tg: 25° C.) | 50 g |
| Melamine resin (solid content: 80%; | 6 g |
| Sumirez Resin SR-613) | |

### Comparative Example 2

A lithographic printing plate precursor was prepared according to the coating and drying of image-receiving layer and the drawing of image in the same manner as in Example 1, except for using a coating composition for inter layer prepared by mixing the components shown below and adding water so as to have a solid concentration of 25%.

| | |
|---|---|
| Calcium carbonate (XA-70 manufactured | 25 g |
| by Maruo Calcium Co., Ltd.) | |
| Colloidal silica (20% aqueous solution) | 20 g |
| (Snowtex C manufactured by Nissan | |
| Chemical Industries, Ltd.; average | |
| particle diameter: 20 nm) | |
| SBR latex (solid content: 50%; Tg: 25° C.) | 30 g |
| Melamine resin (solid content: 80%; | 6 g |
| Sumirez Resin SR-613) | |

With the lithographic printing precursors thus obtained, centerline average roughness (Ra) of the surface of inter layer, contact angle of the surface of inter layer, adhesion of the inter layer to an image-receiving layer, image reproducibility and printing durability were evaluated.

TABLE 1

| | | Comparative | Comparative |
|---|---|---|---|
| | Example 1 | Example 1 | Example 2 |
| Ra of Surface of | 0.5 | 0.01 | 3.0 |
| Inter Layer | | | |
| (μm)*¹⁾ | | | |
| Contact Angle | 15 | 20 | 13 |
| (degree)*²⁾ | | | |
| Adhesion to | Good | Some peeling | Severe peeling |
| Image-Receiving | | | |
| Layer*³⁾ | | | |
| Image Quality*⁴⁾ | Good | Good | Some |
| | | | disappearance of |
| | | | fine letters and |
| | | | fine lines |
| Printing | 15,000 sheets | 7,000 sheets | 3,000 sheets |
| Durability*⁶⁾ | | | |
| Note: | | | |
| *¹⁾Centerline average roughness (Ra) of the surface of inter layer | | | |
| The centerline average roughness (Ra) of the surface of inter layer was measured using a stylus contact type surface roughness measuring instrument (SE-3400 manufactured by Kosaka Laboratory Ltd.). | | | |
| *²⁾Contact angle of the surface of inter layer | | | |
| Two μl of distilled water was put on the surface of inter layer, and after a 30-second lapse a contact angle of water with the surface of inter layer was measured using a surface contact angle meter (CA-D manufactured by Kyowa Interface Science Co., Ltd.). | | | |
| *³⁾Adhesion of the inter layer to an image-receiving layer | | | |
| A adhesive tape having a width of 2 cm (PET base; thickness: 20 μm, manufactured by Nitto Tape Co., Ltd.) was adhered to the image-receiving layer with a load of 500 gf, then the adhesive tape was peeled in the vertical direction to the image-receiving layer at a tensile rate of 10 cm/sec, and peeling of the image-receiving layer was visually observed. | | | |
| *⁴⁾Image reproducibility | | | |
| The images formed on a printing plate and a printed matter were visually observed through an optical microscope at 20 magnifications and 200 magnifications. | | | |
| The printing of lithographic printing plate was conducted using a full-automatic printing machine (AM-2850 manufactured by AM Co., Ltd.), a solution prepared by diluting a PS plate processing agent (EU-3 manufactured by Fuji Photo Film Co., Ltd.) 50 times with distilled water and supplied in a dampening saucer as dampening water, and a black ink for offset printing. The 100th sheet was picked up in the course of printing, and the printed matter was visually observed as described above. | | | |
| *⁵⁾Printing durability | | | |
| The lithographic printing plate prepared as above was subjected to printing using a printing machine (Oliver Model 94 manufactured by Sakurai Seisakusho Co., Ltd.), a solution prepared by diluting a PS plate processing agent (EU-3 manufactured by Fuji Photo Film Co., Ltd.) 50 times with water as dampening water, and a black ink for offset printing. A number of printed matters having clear images without disappearance of | | | |
| # fine lines and fine letters and free from background stain was indicated as the printing durability. | | | |

The lithographic printing plate precursor of Example 1 could provide a large number of good printed matters without peeling of the image-receiving layer at the printing. In Comparative Examples 1 and 2, the adhesion of the image-receiving layer to the inter layer was poor and the printing durability was lower than Example 1. Further, in Comparative Example 2, the image quality was poor. It is believed that the reason for this is the distortion of image formed, particularly fine image formed due to the influence of irregularities on the surface of inter layer on the image-receiving layer.

### EXAMPLE 2

A lithographic printing plate was prepared in the same manner as in Example 1 except for using a laser printer (AMSIS 1200-J Plate Setter) with dry toner, commercially available as AM-Straight Imaging System, to conduct plate-making.

As a result of performing the printing in the same manner as in Example 1, good printed matters of more than 10,000 sheets were obtained without the peeling of image area at the printing.

### EXAMPLE 3

On the same film as described in Example 1 were coated a coating composition for inter layer shown below so as to have a coating amount of 2 g/m² after drying, and then a coating composition for image-receiving layer shown below so as to have a coating amount of 6 g/m² after drying to prepare a lithographic printing plate precursor. The Ra of the surface of inter layer was 0.7 μm. The Bekk smoothness of the surface of image-receiving layer was 500 sec/10 ml.

<Coating Composition for Inter Layer>

| | |
|---|---|
| Zinc oxide (50% aqueous dispersion) | 10 g |
| Methanol silica (solid content: 20%) | 60 g |
| Acryl latex (solid content: 50%; AE872 | 50 g |
| manufacture by JSR Corp.) | |
| Polyvinyl alcohol (10% aqueous solution) | 30 g |
| Melamine resin (solid content: 80%; | 5 g |
| Sumirez Resin SR-613) | |

<Coating Composition for Image-Receiving Layer>

A mixture of 100 g of zinc oxide (Finex-50 manufactured by Sakai Chemical Industry Co., Ltd.; Pauling ionicity rate: 0.59), 113 g of a 10% by weight aqueous solution of polyvinyl alcohol (PVA117 manufactured by Kuraray Co., Ltd.) and 240 g of water was dispersed together with glass beads in a paint shaker (manufactured by Toyo Seiki Co., ltd.) for 30 minutes. Then, 110 g of a 20% by weight mixed solution (water/ethanol=1/1 by weight) of previously hydrolyzed tetraethoxysilane and 200 g of a 20% by weight aqueous dispersion of colloidal silica (Snowtex R503 manufactured by Nissan Chemical Industries, Ltd.) were added thereto and the mixture was dispersed for 3 minutes. The glass beads were removed by filtration to obtain a coating solution for image-receiving layer.

The lithographic printing plate precursor thus obtained was subjected to the plate-making and printing in the same manner as in Example 1. As a result, good printed matters of more than 10,000 sheets were obtained without the peeling of image area at the printing.

### EXAMPLE 4

A lithographic printing plate precursor was prepared in the same manner as in Example 1 except for forming an image-recording layer using a coating composition for image-recording layer shown below in a manner shown below, and the plate-making and printing were performed in the same manner as in Example 1 using the resulting lithographic printing plate precursor.

<Coating Composition for Image-Receiving Layer>

A mixture of 100 g of zinc oxide hydrate (PC-101 manufactured by Titan Kogyo Kabushiki Kaisha; average particle diameter: 40 nm), 90 g of a 10% by weight aqueous solution of sulfonic acid-modified polyvinyl alcohol (SK-5102 manufactured by Kuraray Co., Ltd.; modification amount: 25% by mole) and 240 g of water was dispersed in a paint shaker (manufactured by Toyo Seiki Co., ltd.) for 30 minutes. Then, 107 g of a 20% by weight mixed solution (water/ethanol=1/1 by weight) of previously hydrolyzed tetramethoxysilane and 182 g of a 20% by weight aqueous solution of colloidal silica (Snowtex C manufactured by Nissan Chemical Industries, Ltd.) were added thereto to obtain a coating solution for image-receiving layer.

The coating solution for image-receiving layer was coated on the inter layer using a wire bar and dried at 100° C. for 10 minutes in an oven to prepare an image-receiving layer having a dry coating amount of 5 g/m², whereby a lithographic printing plate precursor was obtained.

As a result, good printed matters of more than 10,000 sheets were obtained without the peeling of image area at the printing.

According to the present invention, a lithographic printing plate capable of providing printed matters having clear images and excellent in printing durability can be prepared.

The entire disclosure of each and every foreign patent application from which the benefit of foreign priority has been claimed in the present application is incorporated herein by reference, as if fully set forth herein.

While the invention has been described in detail and with reference to specific examples thereof, it will be apparent to one skilled in the art that various changes and modifications can be made therein without departing from the spirit and scope thereof.

What is claimed is:

1. A lithographic printing plate precursor comprising at least an inter layer and an image-receiving layer provided in order on a water-resistant support, wherein the inter layer has a surface exhibiting a centerline average roughness (Ra) of from 0.05 to 2.0 μm.

2. The lithographic printing plate precursor as claimed in claim 1, wherein the inter layer contains a resin and fine particles of inorganic pigment having an average particle diameter of from 0.005 to 1 μm.

3. The lithographic printing plate precursor as claimed in claim 2, wherein the fine particle of inorganic pigment having an average particle diameter of from 0.005 to 1 μm is at least one kind of inorganic pigment selected from colloidal silica, titania sol and alumina sol.

4. The lithographic printing plate precursor as claimed in claim 1, wherein the water-resistant support is a polymer film or a composite film, and the polymer film or composite film has a coefficient of thermal expansion of not more than 15×10⁻⁵/° C. and a coefficient of thermal shrinkage of from −1.0 to less than +1.0 under heating at 150° C. for 30 minutes.

5. The lithographic printing plate precursor as claimed in claim 1, wherein the image-receiving layer contains at least one kind of particle selected from a metal oxide hydrate particle, a metal oxide particle and a double oxide particle each having an average particle diameter of from 0.01 to 5 μm and being composed of atoms having a Pauling ionicity rate of not less than 0.2 between the atoms and a binder resin comprising a complex of a resin containing a siloxane bond wherein a silicon atom is connected with an oxygen atom and an organic polymer containing a group capable of forming a hydrogen bond with the resin containing a siloxane bond.

6. The lithographic printing plate precursor as claimed in claim 5, wherein the resin containing a siloxane bond is a polymer obtained by a hydrolysis co-condensation of at least one silane compound represented by the following formula (III):
(R⁰)ₘSi(Y)₄₋ₘ (III)
wherein R⁰ represents a hydrogen atoms, a hydrocarbon group or a heterocyclic group; Y represents a reactive group; and m represents 0, 1 or 2, provided that the silicon atom is not connected to 3 hydrogen atoms or 4 hydrogen atoms.

7. The lithographic printing plate precursor as claimed in claim 1, wherein the image-receiving layer is a layer formed from a dispersion containing silica particles having an average particle diameter of from 1 to 6 μm and ultra-fine particles of inorganic pigment having an average particle diameter of from 5 to 50 nm in a weight ratio of from 40/60 to 70/30, as an inorganic pigment and at least one kind of hydrophilic resin modified with a silyl functional group represented by the following formula (I):
—Si(R)ₙ(OX)₃₋ₙ (I)
wherein R represents a hydrogen atom or a hydrocarbon group having from 1 to 12 carbon atoms, X represents an aliphatic group having from 1 to 12 carbon atoms, and n represents 0, 1 or 2.

8. The lithographic printing plate precursor as claimed in claim 7, wherein the image-receiving layer is a layer formed from the dispersion further containing gelatin and a gelatin hardening compound.

9. The lithographic printing plate precursor as claimed in claim 7, wherein the ultra-fine particles of inorganic pigment having an average particle diameter of from 5 to 50 nm is at least one inorganic pigment selected from colloidal silica, titania sol and alumina sol.

10. The lithographic printing plate precursor as claimed in claim 8, wherein the gelatin hardening compound is a compound containing at least two double bond groups represented by formula (II) shown below in the molecule thereof.
CH₂═CH—W— (II)
wherein W represents —OSO₂—, —SO₂—, —CONR¹— or —SO₂NR¹— (wherein R¹ represents a hydrogen atom or an aliphatic group having from 1 to 8 carbon atoms.

11. The lithographic printing plate precursor as claimed in claim 1, wherein the image-receiving layer has a surface smoothness of not less than 30 (sec/10 ml) in terms of Bekk smoothness.

12. The direct drawing type lithographic printing plate precursor as claimed in claim 5, wherein the organic polymer is a polymer containing at least one member selected from the group consisting of an amido bond, a urethane bond, a ureido bond and a hydroxy group.

13. The direct drawing type lithographic printing plate precursor as claimed in claim 12, wherein the organic polymer is an amide resin having an —N(R¹¹)CO— or —N(R¹¹)SO₂— bond, wherein R¹¹ represents a hydrogen atom, a hydrocarbon group or a heterocyclic group, a ureide resin having an —NRCONH— bond, or a urethane resin having an —NHCOO— bond.

14. The direct drawing type lithographic printing plate precursor as claimed in claim 12, wherein the organic polymer is a polymer containing a repeating unit represented by the following formula (IV): 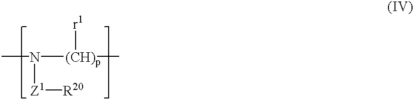
wherein, Z¹ represents —CO—, —SO₂— or —CS—; R²⁰ represents a hydrogen atom, a hydrocarbon group or a heterocyclic group; r¹ represents a hydrogen atom or an alkyl group having from 1 to 6 carbon atoms, r¹s may be the same or different; and p represents an integer of 2 or 3.

15. The direct drawing type lithographic printing plate precursor as claimed in claim 5, wherein the complex has a weight ratio of the resin containing a siloxane bond/the organic polymer of from 10/90 to 90/10.

16. The direct drawing type lithographic printing plate precursor as claimed in claim 1, wherein the image-receiving layer has a thickness of from 0.2 to 10 μm.

17. The direct drawing type lithographic printing plate precursor as claimed in claim 1, wherein the water-resistant support has a surface smoothness of the side opposite to the side on which the inter layer is coated of from 5 to 2,000 seconds/10 ml in terms of Bekk smoothness.

18. The direct drawing type lithographic printing plate precursor as claimed in claim 1, wherein the water-resistant support has a specific electric resistance of not more than 10¹⁰ Ω·cm.
